(19) United States
(12) Patent Application Publication
(10) Pub. No.: US 2007/0136413 A1
(43) Pub. Date: Jun. 14, 2007

(54) SIP SERVER SHARING MODULE AND SIP MESSAGE RELAY SYSTEM

(75) Inventors: Yuuichi Ishikawa, Tokyo (JP); Akira Tsukamoto, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 11/608,033

(22) Filed: Dec. 7, 2006

(30) Foreign Application Priority Data
Dec. 8, 2005 (JP) 2005-355328

(51) Int. Cl. G06F 15/16

(52) U.S. Cl. 709/200

(57) ABSTRACT

An SIP (Session Initiation Protocol) server sharing module relays SIP messages which are transmitted and received between a plurality of client groups and a SIP proxy server shared by the plurality of client groups. The SIP server sharing module includes a message source group identifying section configured to identify a specific client group to which a specific client terminal belongs which transmits a client transmission SIP message, from the client transmission SIP message which is transmitted to the SIP proxy server from each of client terminals belonging to the plurality of client groups, and a group tag insetting section configured to insert a group tag corresponding to the specific client group identified by the message source group identifying section in the client transmission SIP message. A group tag removing section removes a group tag contained in a server transmission SIP message transmitted to a destination client terminal, which belongs to the specific client group, from the SIP proxy server. A message destination group identifying section prevents the server transmission SIP message from being transmitted to a client terminal which belongs to a client group different from the specific client group corresponding to the group tag contained in the server transmission SIP message.

### BACKGROUND OF THE INVENTION

1. Field of the Invention

The present invention relates to a SIP (Session Initiation Protocol) server sharing module, and more specifically, to a SIP server sharing module that allows a plurality of client groups to share a SIP proxy server safely.

2. Description of the Related Art

Conventionally, as a method for allowing a plurality of client groups to share application servers provided within a data center, e.g., a Web cache server, a mail server, a database server, a SIP (Session Initiation Protocol) proxy server, a method is generally employed in which VLAN (virtual Local Area Network) is built within the data center for each client group, and each of the application servers is provided on the VLANs (for each of the client groups). In this method, however, it is necessary to build VLANs and provide the application servers for each client group. Thus, it is difficult to accommodate a large number of client groups within the data center in terms of cost.

As a method for overcoming this problem, a method may be considered which provides a module (referred to as a sharing module hereinafter) for carrying out a relay process of requests/responses exchanged between client terminals and a server at a preceding stage of the application server, thereby allowing a plurality of client groups to share a single application server through the use of the sharing module.

The sharing module needs to have following functions.
(1) The sharing module needs to perform the relay process of the request/response messages that are exchanged between the client terminals and the application server while providing security to each client group that as if it is in use of an exclusive application server, even though a single server is used in common by a plurality of client groups.
(2) in order to achieve (1) described above, it is necessary to intercept all the request/response messages that are exchanged between the client terminals and the application server in the sharing module. Further, it is necessary to transfer the intercepted request/response messages to the client terminal or the application server that is the original transmission destination. Specifically, the request/response messages of the following (a), (b), and (c) are targets of interception and transfer.
   (a) A request message transmitted from a client terminal to the application server.
   (b) A response message transmitted form the application server to the client terminal.
   (c) A request message which is transmitted from a client terminal to another client terminal and is transferred in the application server.

As a method for achieving the above (1), a method is conventionally proposed that is targeted at Web cache server, for example. In this method, a sharing module is provided within a same node as that of the Web cache server for allowing a plurality of client groups to share the Web cache server. Interception of the request/response noted in the above (2) is not particularly any problem in this method. When the Web cache server caches the Web contents browsed by a client terminal, the sharing module identifies the client group to which the client terminal belongs, and gives URL (Universal Resource Locator) of the contents to be cached to the Web cache server after inserting a group tag indicating the client group. For example, when caching the contents of URL www.a.com/index.html, browsed by a client terminal that belongs to client group 1, a group tag “group-1” is inserted into the URL. As a result, it is cached on the Web cache server with the URL www.a.com-group1/index html.

When the client terminal browses the contents cached on the Web cache server, the sharing module inserts, to the URL of the contents requested by the client terminal, the group tag that indicates the client group to which the client terminal belongs. For example, when a client terminal belonging to a client group 2 requests to browse the contents of the URL www.a.com/index.html, the URL www,a.com-group2/index.html is given to the Web cache server, and the Web cache server searches for the contents cached under this URL. After the search, the sharing module transmits, to the client terminal that is the source of the browse request, a response for the browse request transmitted by that client terminal.

With this, the contents cached by the browse request of the client terminal that belongs to a specific client group can only be accessed from the client terminals belonging to that client group. As a result, even though a single Web cache server is used in common by a plurality of client groups, it is possible to provide security to each client group as if it is in use of the exclusive cache server.

As a method for achieving the above (2), for example, there is a method which makes the sharing module to function as a so-called proxy server by using typical proxy server software such as Squid. In this method, the sharing module behaves as an application server for the client terminal, and behaves as a client terminal for the application server. Specifically, the sharing module transfer a request received from the client terminal to the application server that is set in advance. Further, an identifier of the client terminal as the source of a request is stored when transferring the request from the client terminal, and when a response for the request is received from the application server, the response is transferred to the client terminal with the stored identifier.

A first problem of the conventional technique is that the above-described technique for achieving the above (1) faces to following problems (A) and (B), since the group tag is inserted to the data (contents cached in the Web cache server) which is registered to the application server.
(A) After the client terminal changes the belonging group, the client terminal cannot use the cached contents even if the contents are cached when being browsed by that client terminal. After changing the group, it is necessary to re-cache the contents anew. Further, even after the client terminal changes the group, the contents cached through browsing of that client terminal can be browsed by the terminals of the client group to which the client terminal has belonged previously.
(B) When the client group is removed, the unnecessary cache contents remain on the cache server forever unless the cached contents are cancelled explicitly from the Web cache server. Further, when a new client group is formed, the contents cached through browsing by a client terminal before this client terminal joins the newly formed client group cannot be used by the new client group, even after the client terminal joins to that group. It is necessary to cache the contents again.

When the above-described conventional technique for achieving the above (1) is directly applied to the SIP, the group tag is inserted to URI (Universal Resource Indicator) to be registered to a SIP proxy server by the client terminal with a REGISTER message. In that case, as in the above-described problem, the REGISTER message has to be retransmitted after changing the client group, or there may receive a call from the outside of the own client group, unless the URI registered previously is canceled explicitly from the SIP proxy server after the changing. Supposing that retransmission of the REGISTER message, cancellation of the registered entry, etc. after changing the group are to be carried out, there is a load imposed upon the SIP proxy server due to the process thereof every time the client terminal changes the group. Thus, the conventional technique cannot deal with dynamic change of the client terminal between the client groups, and dynamic forming or canceling of the client group.

A second problem of the conventional technique is as follows. In the conventional technique for achieving the above (2), a response for the client terminal from the application server is transmitted to the client terminal that is the source of the request that is a trigger of the response. Thus, from the time point that the request is received from the client terminal until the time point that the response for the request is received from the server and it is relayed to the client terminal, data regarding from which of the client terminals the request has been transmitted needs to be retained. Therefore, when the relay process of a vast amount of request/response messages is to be carried out simultaneously, the data quantity retained in the sharing module becomes extensive, thereby imposing a heavy load on the sharing module.

In case of a SIP, the data of the client terminal as a response transmission destination is written in the response message that is transmitted from the SIP proxy server to the client terminal. Thus, if this data is used, it is unnecessary to retain the data in the sharing module. However, the data may be misrepresented since the data is written based on the self declaration reported by the client terminal as the source of the request (request message). If it is misrepresented, the response may be transmitted to the client terminal that is irrelevant to the request source,

Furthermore, the conventional technique for achieving the above (2) is not provided with the function of the above (c) for intercepting the request message to be transmitted from the client terminal to another client terminal, which message is transferred to the client terminal as the original transmission destination in the application server.

In conjunction with the above description, Japanese Laid Open Patent Application (UP-P2004-30309A) discloses a shared cache server.

In this conventional technique, a shared cache server, which is provided on a common network where a plurality of virtually isolated virtual networks are built by corresponding to a plurality of groups, includes a memory device, a plurality of virtual interfaces, an address converting function, and a cache function. In this shared cache server, a memory unit stores contents in each of a plurality of storage areas corresponding to the plurality of groups. Virtual interfaces (VIF) 1 and 2 are arranged in accordance with the plurality of virtual networks. Upon receiving a packet for requesting contents from a client through the VIF, an address converting function converts a part of IP address in the packet into an internal address corresponding to the VIF. A cache function reads out the contents of the corresponding group from the storage area of the memory unit based on the internal address converted by the address converting function.

Also, Japanese Laid Open Patent Application (JP-P2005-33702A) discloses a communication apparatus. This communication apparatus is connected to a VPFN (virtual private network) holding device to which a plurality of VPNs and a global network are connected. The communication apparatus includes a communication application platform, a SIP Proxy section, and a communication application program. The communication application platform transmits a SIP message received from the VPN holding device to the SIP Proxy section and transmits the SIP message with the converted IP address received from the SIP Proxy section to the VPN holding device. The SIP Proxy section carries out a SIP Proxy process on the SIP message received from the communication application platform. Then, the SIP proxy device transmits the SIP message to the communication application program, while transmitting the SIP message with the converted IP address received from the communication application program to the communication application platform. The communication application program converts the IP address within the SIP message received from the SIP Proxy section into an IP address of a proper address system, and transmits the SIP message with the converted IP address to the SIP Proxy section.

Also, Japanese Laid Open Patent Application (JP-P2005-20080A) discloses a communication system between subscriber terminals. In this conventional technique, in the communication system between the subscriber terminals under VLAN environment, a SIP server for executing Internet protocol for setting calls of IP (Internet protocol) telephones includes a media switching device and a conversion table. The media switching device rewrites an IP address and a port number of the own subscriber terminal designated as a receiver of media signals within a call control message transmitted from the subscriber terminal that is connected to the VLAN into the pooled IP address and port number of the SIP server that can be used. The conversion table saves the rewritten relevance data. At the time of communicating the media signals, the media switching device transmits the media signals directed to the IP address and the port number of the SIP server received from the subscriber terminal to the converted IP address and the port number of the target subscriber terminal based on the conversion table.

Also, Japanese Laid Open Patent Application (JP-P2004-179853A) discloses a server apparatus. In this conventional technique, a server apparatus capable of communicating with each of a plurality of virtual closed-area networks that may have the same IP S addresses includes a device for storing a physical address of the communication device as a source within a layer 2 frame of a reception packet; and a setting section for setting, regardless of the IP address of the response target, the physical address as a layer 2 address as the target of transmitting a response packet when transmitting the response packet to the reception packet.

Also, Japanese Laid Open Patent Application (JP-P2004-165823A) discloses an IP address converting device. This IP address converting device includes a receiving section, an extraction section, a judging section, a replacing section, a correspondence managing table, a converting section, and a transmitting section. The receiving section receives a SIP message. The extraction section extracts IP address data within the SIP message received by the receiving device. The judging section determines whether or not there is contained an IP address in the IP address data extracted by the extraction device and, when the IP address is contained in the extracted IP address data, decides whether or not there requires conversion of the extracted IP address to the virtual IP address. The replacing section replaces the IP address that is determined as unnecessary to be converted to the virtual IP address with IP address identification data in the judging section. The correspondence managing table registers the correspondence relation between the IP address identification data reprovided by the replacing section and the IP address. The converting section converts the IP address that is determined by the judging section as necessary to be converted to the virtual IP address into the virtual IP address. The transmitting section transmits the SIP message with the modified IP address data.

Japanese Laid Open Patent Application (JP-P2004-147195A) discloses an audio communication method. In this audio communication method, a source terminal device transmits a call connection request to a first gate device that manages a source terminal device. The first gate device upon receiving the call connection request transmits through a public telephone network, first call control data to a second gate device that manages a transmission destination terminal device. The second gate device transmits the call connection request to the transmission destination terminal device. The transmission destination terminal device transmits a response indicating communicable or incommunicable to the second gate device. When receiving the response from the transmission destination terminal device indicating that it is communicable, the second gate device transmits second call control data to the first gate device through the public telephone network, and opens a port connected to an IP network. The first gate device opens a port connected to the IP network upon receiving the second call control data from the second gate device. The source terminal device and the transmission destination terminal device exchange communication by packet communication through the opened ports of the first and second gate devices and the IP network.

Also, a load distribution apparatus is disclosed in Japanese Laid Open Patent Application (JP-P2003-242057A). This conventional example is the load distribution apparatus which transmits a delivery request from a user terminal to one of a plurality of servers which is selected. The conventional load distribution apparatus includes a load distribution group identifying section for identifying one load distribution group to which the user terminal transmitting the delivery request belongs, and a user group session management section for managing the current number or connection sessions and the number of maximum connectable sessions for every user group. A server group session management section manages the current number of connection sessions and the number of maximum connectable sessions for every server group. A server session management section manages the current number of connection sessions and the number of maximum connectable sessions for every server. A user group server group identifying section identifies the user group to which the user terminal belongs and the server group as a transmission destination of the delivery request. A user group reception determining section refers to the user group session management section and carries out a process of refusing a delivery request packet or a process of delivering the delivery request packet to another load distribution apparatus, when the current number of sessions in a connection state in the user group to which the user terminal belongs is equal to or more than the number of maximum connectable possible sessions. A server group reception determining section refers to the server group session management section and carries out a process of refusing the delivery request packet or a process of delivering the delivery request packet to another load distribution apparatus, when the current number of sessions in a connection state in the server group as the transmission destination of the delivery request is equal to or more than the number of maximum connectable sessions. A server reception determining section refers to the server session management section and carries out a process of refusing the delivery request or a process of delivering the delivery request to another load distribution apparatus, when the number of sessions in the connection state is equal to or more than the number of maximum connectable session in all the servers of the server group as the transmission destinations of the delivery request. A destination server selection section selects one server for the delivery request to be delivered from among the server group as the transmission destinations of the delivery request based on load distribution algorithm which is previously set for every load distribution group. Each of a plurality of load distribution group process sections is provided for one load distribution group and includes the above sections. A quality control section carries out a band control for every load distribution group and carries out a priority control in the load distribution group.

### SUMMARY OF THE INVENTION

An object of the present invention is to provide a SIP server sharing module which can provide security to each of a plurality of client groups as if it is in use of an exclusive application server, even though a single SIP proxy server (or a plurality of SIP proxy servers) is used in common by the plurality of client groups.

Another object of the present invention is to provide a SIP server sharing module which can deal with dynamic change of a client terminal between client groups, and dynamic forming or canceling of the client group when the client terminal changes between the client groups, through allowance of reception of call termination from the changed client group and refusal of call termination from the client group to which the client terminal has belonged before the change, without retransmitting a REGISTER message or canceling the registered URI.

Still another object of the present invention is to provide a SIP server sharing module which can prevent a response transmitted from a SIP proxy server or a transferred request from being transmitted to the outside of the client group to which the client terminal as the source of the response or the request as a trigger of the response belongs, without retaining the data of the request-source terminal in a sharing module.

In an aspect of the present invention, a SIP (Session Initiation Protocol) server sharing module relays SIP messages which are transmitted and received between a plurality of client groups and a SIP proxy server shared by the plurality of client groups. The SIP server sharing module includes a message source group identifying section configured to identify a specific client group to which a specific client terminal belongs which transmits a client transmission SIP message, from the client transmission SIP message which is transmitted to the SIP proxy server from each of client terminals belonging to the plurality of client groups, and a group tag insetting section configured to insert a group tag corresponding to the specific client group identified by the message source group identifying section in the client transmission SIP message. A group tag removing section removes a group tag contained in a server transmission SIP message transmitted to a destination client terminal, which belongs to the specific client group, from the SIP proxy server. A message destination group identifying section prevents the server transmission SIP message from being transmitted to a client terminal which belongs to a client group different from the specific client group corresponding to the group tag contained in the server transmission SIP message.

Here, the message destination group identifying section may transfer the server transmission SIP message to the destination client terminal, when the specific client group corresponding to the group tag contained in the server transmission SIP message and a client group to which the destination client terminal of the server transmission SIP message belongs are coincident with each other.

Also, when a plurality of virtual or physical network interfaces exists in a node where the SIP server sharing module is provided, the message destination group identifying section may specify a network interface different for every client group corresponding to the group tag contained in the server transmission SIP message and transmit the server transmission SIP message.

Also, the message destination group identifying section may convert a parameter contained in an IP header or UDP header of the server transmission SIP message into a parameter area different for every client group corresponding to the group tag contained in the server transmission SIP message, and then transmit the server transmission SIP message to the destination client terminal.

Also, the group tag insetting section may insert the group tag corresponding to the specific client group identified by the message source group identifying section, into either of parameters, that meet a condition that the parameters does not contain URI to be registered on the SIP proxy server, the parameters is not erased through the transfer process by the SIP proxy server, and a same value is written in a request message and a response message transmitted from the SIP proxy server in response to reception of the request message, among parameters contained in the client transmission SIP messages.

Also, the group tag insetting section may insert the group tag corresponding to the specific client group identified by the message source group identifying section into a portion of a user identifier of URI contained in a header section of the client transmission SIP message.

Also, the group tag insetting section may further insert the group tag in a body section of the client transmission SIP message, when the client transmission SIP message is a message to notify presence data to the SIP proxy server.

Also, when the message source group identifying section identifies the plurality of client groups, the group tag insetting section may produce copies of the client transmission SIP message for the plurality of client groups identified by the message source group identifying section, and insert the group tag corresponding to each of the plurality of client groups identified by the message source group identifying section into corresponding one of the copies.

Also, the group tag insetting section may additionally write an IP address of a node in which the SIP server sharing module is arranged and a port number used for waiting for the SIP message into a Via header of the client transmission SIP message, when the client transmission SIP message is a request message. When the server transmission SIP message is a response message to the request message, the group tag removing section may remove the IP address and the port number used from the Via header of the client transmission SIP message, and set an IP address and a port number of a client terminal written in the Via header of the server transmission SIP message to a destination IP address of a IP header and a destination port number of the UDP header of the IP header of the server transmission SIP message.

Also, the SIP server sharing module may further include address conversion rule; and an address converting section. In the address conversion rule, is described an address conversion method of mutually converting an original address as an address which the client terminal requests to register on the SIP proxy server by use of a REGISTER message, and an interception address as an address to intercept the SIP message when being set in a destination address of the SIP message transmitted by the SIP proxy server. The address converting section may convert an original address contained in a Contact header of the client transmission SIP message into the interception address by referring to the address conversion rule, when the client transmission SIP message is a REGISTER message, converts the interception address contained in the Contact header of the server transmission SIP message into the original address by referring to the address conversion rule, when the server transmission SIP message is the response message to the REGISTER message, and converts an interception address specified by an IP header and a UDP header of the server transmission SIP message into the original address by referring to the address conversion rule, when the server transmission SIP message is the request message.

In this case, the address conversion method may be a conversion method of mutually converting an address a which is an optional IP address contained in an IP address area A having a width of M bits, which is a destination of UDP or TCP, or which constitutes a pair with a source port number, and an address b which is an optional IP address contained in an IP address area B having a width of N bits, which is a destination of UDP or TCP or which constitutes a pair with a source port number. In the address conversion method, an X-bit portion meeting X<N in the IP address of the address a is mapped to the IP address of the address b, and a remaining (M-X)-bit portion is mapped to the destination of UDP or TCP or the source port number of the address b, in case of conversion of the address a into the address b. Also, a combination of an X-bit portion of the IP address of the address b, and an (M-X)-bit portion of the destination of UDP or TCP or the source port number of the address b is mapped to the IP address of the address a, in case of conversion of the address b into the address a.

Also, the address conversion rule may use the IP address area when the SIP server sharing module is set as a gateway in the SIP proxy server as an interception address.

Also, the address conversion rule may use an IP address area contained in a local loop back address area as an interception address.

In another aspect of the present invention, in an address conversion method, an address a which is an optional IP address contained in an IP address area A with a width of M bits, is a destination of UDP or TCP, or constitutes a pair with a source port number, and an address b which is an optional IP address contained in an IP address area B with a width of N bits, is a destination of UDP or TCP, or constitutes a pair with a source port number are mutually converted. The address conversion method is achieved by (A) mapping an X-bit portion meeting X<N of the IP address of the address a to the IP address of the address b in case to convert the address a into the address b; by (B) mapping a remaining (M-X)-bit portion of the IP address of the address a to the destination of UDP or TCP of the address b, or the source port number; and by (C) mapping a combination of an X-bit portion of the IP address of the address b and an (M-X)-bit portion of the destination of UDP or TCP of the address b or the source port number into the IP address of the address a in case of conversion of the address b into the address a.

In another aspect of the present invention, a method of relaying a SIP message is achieved by (a) when a message is received, determining whether the message is transmitted from a client terminal or a SIP proxy server; by (b) determining whether or not address conversion is necessary when the received message is from the client terminal; by (c) transferring the received message to the SIP proxy server without any process when the address conversion is not necessary; by (d) determining whether or not the received message is a REGISTER message, when the address conversion is necessary; by (e) carrying out a forward conversion an original address as an IP address or a port number contained in a Contact header of a header section, when the received message is the REGISTER message; and by (f) transmitting the REGISTER message to the SIP proxy server after the forward conversion.

Also, the method may be achieved by further (g) determining whether or not the address conversion is necessary, when the received message is a SIP message from the SIP proxy server; (h) removing a group tag contained in the SIP message when the address conversion is unnecessary; (i) determining whether or not the SIP message is a request message, when the address conversion is necessary; (j) carrying out an inverse conversion of a destination address or a destination port number of an IP header of the SIP message from an intercept address to the original address such that the SIP message is transferred to the client terminal, when the SIP message is a request message; and (k) removing a group tag contained in the SIP message after the inverse conversion.

Also, the method may be achieved by further (1) determining whether the SIP message is a response message to the REGISTER message, when the SIP message is the response message; (m) carrying out inverse conversion of an IP address contained in the Contact header or the interception address as a port number into the original address, when the SIP message is the response message to the REGISTER message; and (n) removing a group tag contained in the SIP message after the inverse conversion.

In another aspect of the present invention, a computer-readable software product realizes a method of relaying a SIP message.

### BRIEF DESCRIPTION OF THE DRAWINGS

FIG. 1 is a block diagram showing the configuration of a SIP server sharing module according to the present invention;

FIG. 2 is a diagram showing a typical SIP communication network in network-level client groups;

FIG. 3 is a table showing packet transfer rules set for a VPN gateway;

FIG. 4 is a diagram showing a typical SIP communication network in case of application-level client groups;

FIG. 5 is a diagram showing a typical SIP communication network in case of the application-level client groups;

FIG. 6 is a diagram showing an example of the configuration of the SIP communication network, when the SIP server sharing module of the present invention is placed alone in a node;

FIG. 7 is a diagram showing an example of the configuration of the SIP communication network, when the SIP server sharing module of the present invention is placed within a same node as a VPN termination section;

FIG. 8 is a diagram showing an example of the configuration of the SIP communication network, when the SIP server sharing module of the present invention is placed within a same node as a SIP proxy server;

FIG. 9 is a diagram showing a message source group identifying table that is held by a message source group identifying section in the SIP server sharing module of the present invention;

FIG. 10 is a diagram showing the message configuration when there is a tunneling link built between the SIP proxy server and the SIP server sharing module;

FIG. 11 is a flowchart for showing the operation of an address converting section in the SIP server sharing module of the present invention;

FIG. 12 is a diagram showing a message destination group identifying table that is held by a message destination group identifying section in the SIP server sharing module of the present invention;

FIGS. 13A and 13B are a sequence chart for showing the operation when the SIP server sharing module of the present invention transfers to the SIP proxy server, a request message that is transmitted from a client terminal;

FIGS. 14A to 14E are diagrams showing the operations when the SIP server sharing module of the present invention transfers the request message from the client terminal to the SIP proxy server;

FIG. 15 is a diagram showing an address conversion rule that is set in an address conversion table in the SIP server sharing module of the present invention;

FIG. 16 is a sequence chart for showing the operation when the SIP server sharing module of the present invention transfers a response message from the SIP proxy server to the client terminal;

FIGS. 17A to 17D are diagrams showing the message configurations when the SIP server sharing module of the present invention transfers the response message from the SIP proxy server to the client terminal;

FIG. 18 is a sequence chart for showing the operation when the SIP server sharing module of the present invention transfers the request message from the SIP proxy server to the client terminal; and

FIGS. 19A to 19E are diagrams showing the message configurations when the SIP server sharing module of the present invention transfers the request message from the SIP proxy server to the client terminal.

### DESCRIPTION OF THE PREFERRED EMBODIMENTS

Hereinafter, a SIP (Session Initiation Protocol) server network system of the present invention will be described in detail with reference to the attached drawings.

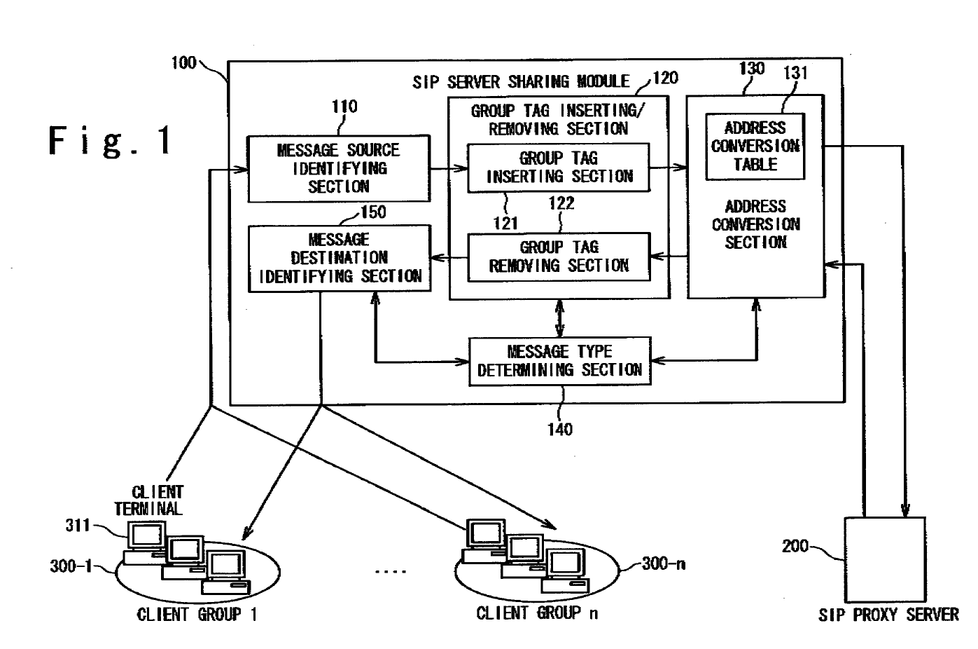

The SIP server network system using a SIP server sharing module according to the first embodiment of the present invention will be described below in detail. FIG. 1 is a block diagram showing the configuration of the SIP server network system according to the first embodiment of the present invention.

As shown in FIG. 1, the SIP server network system of the present invention includes a SIP server sharing module 100, a SIP proxy server 200, and a plurality of client groups 300-i (i=1 to n). The SIP server sharing module 100 is provided between the plurality of client groups 300-i and the SIP proxy server 200. The SIP proxy server 200 is shared by client terminals belonging to the client groups, and the SIP server sharing module 100 carries out a relaying process of messages exchanged between the client terminals and the SIP proxy server 200. The SIP proxy server 200 is a server for carrying out the processes of (Process 1) to (Process 4) described below. There may be cases where a function of executing some of the processes from (Process 2) to (Process 4) is not mounted, or there is additionally mounted a function of executing a process other than the processes of (Process 1) to (Process 4). In the following description, however, the servers including those types are all referred to as the SIP proxy servers.

(Process 1) Registering Process of Client Terminal Data

By this process, a register message (REGISTER message) is received from a client terminal, and registers a SIP URI (Universal Resource Indicator) of the client terminal and a contact address (IP (Internet protocol) address and a SIP waiting port number of the client terminal) to a database. The REGISTER message may include data regarding the use purpose or characteristic of the client terminal as the additional data of the contact address.

(Process 2) Message Transferring Process Between Client Terminals

A message transmitted from a client terminal is transferred to another client terminal by this process. The message to be transferred mainly contains a message (2-1) (INVITE message, REFER message, BYE message, CANCEL message, etc.) for carrying out call control such as establishing, ending, transferring or the like of calls, a message (2-2) (PUBLISH message, NOTIFY message, etc.) for notifying the state of the client terminal (presence data), a message (2-3) (MESSAGE message, etc.) for exchanging arbitrary data mainly when chatting or the like are carried out between the client terminals, a general-purpose message (2-4) (ACK message, etc.) for checking the arrival of the message between the client terminals regardless of the above-described purposes, etc.

(Process 3) Registering Request Process for Data Notification

By this process, the registering request message (SUBSCRIBE message, etc.) is received which is used to transmit from the client terminal to specific data (for example, presence data of other client terminals).

(Process 4) Responding Process for Inquiries About Client Terminal Data

By this process, registered data of other client terminals are returned upon receiving a request message (OPTIONS message, etc.) from a client terminal.

The SIP proxy server is characterized to carry out the processes from (Process 2) to (Process 4) based on the data registered in (Process 1). In (Process 2), the transmission destination of a message transmitted from the client terminal is expressed with SIP URI of the transmission destination client terminal, and a contact address corresponding to the SIP URI of the transmission destination client terminal is settled based on the data registered in (Process 1). Also, the message is transmitted to the contact address. In (Process 3), the data to be received is designated by SIP URI, and the relation between the SIP URI and the client terminal that has issued the request to receive the data is registered based on the data registered in (Process 1). In (Process 4), the client terminal as an inquiry target client terminal is expressed with SIP URI, and the registered data corresponding to the inquired SIP URI is returned based on the data registered in (Process 1).

The SIP proxy server 200 notifies the process result to the request source in the form of a response message, upon receiving a message which requires the processes from (Process 1) to (Process 4) described above, such as REGISTER, INVITE, REFER, BYE, CANCEL, PUBLISH, MESSAGE, ACK, SUBSCRIBE, OPTIONS, etc., which are generally referred to as request messages.

A client terminal 311 is not limited to a personal computer, and is a terminal loaded with a SIP protocol compatible application (SIP UA (User Agent)) that is compatible with an IP telephone terminal, data home appliances, and so on. The client terminal constitutes a client group together with at least one client terminal.

The client group 300-i is a set of client terminals that do not desire communication, message exchange, notification of presence data, disclosure of registered data, and so on between the client terminals that do not belong to the same group and the concerned client terminal. The present invention considers, as the client group, the client groups in terms of the network level and the client groups in terms of the application level, to be described below. The client group of the network level is a group of the client terminals connected within a closed network, such as the client terminals connected to a same corporation intranet or department intranet within the corporation, in which the connection is secured with other terminals that connected to the same network and no connection is secured with the external networks (or there is only connection secured by a very limited application such as Web and Mail). For the group of the network level, the client group is uniquely specified when the network is specified. In addition to the corporation intranet and the department intranet described above, the client group of the network level also includes a group which constitutes a virtually closed network, such as Softether or Emotion Link, by connecting to other client terminals within the group on a public network by using IPSec tunnel, SSL tunnel or the like.

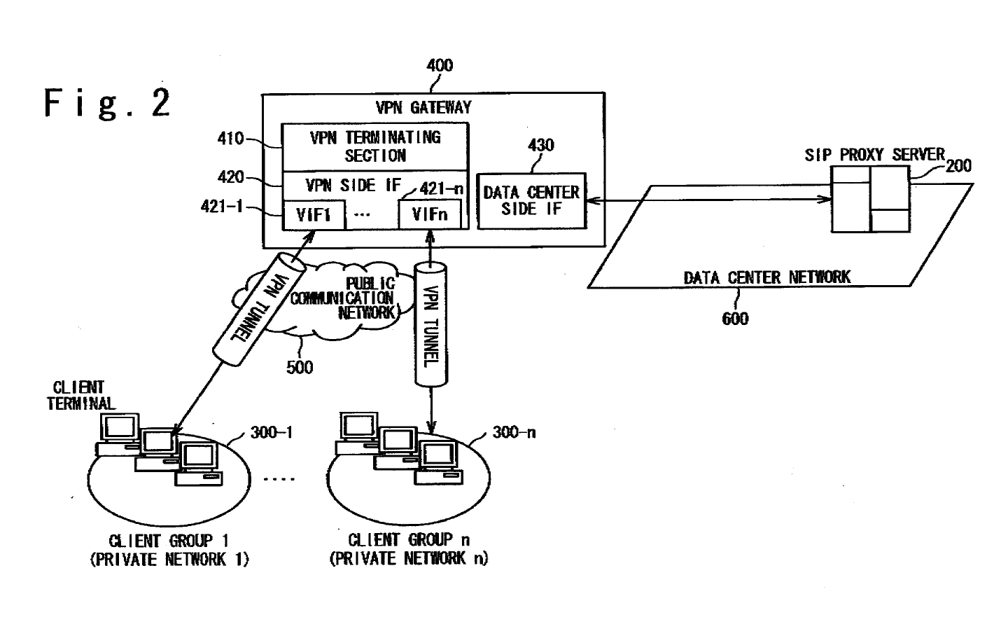

FIG. 2 shows an example of network configuration when the client groups of the network level communicate with the SIP proxy server 200, In FIG. 2, the client group 300-i correspond to each of private networks (the same corporation intranet, the department intranet within the corporation, and virtually closed networks formed by connecting client terminals participated in the same client group on the public network by using the IPSec tunnel, the SSL tunnel or the like), and the client groups 300-i are connected to a data center network 600 where the SIP proxy server 200 is placed, through VPN tunnels whose communication securities are secured by IPSec, SSL or the like on a public network 500 such as the Internet.

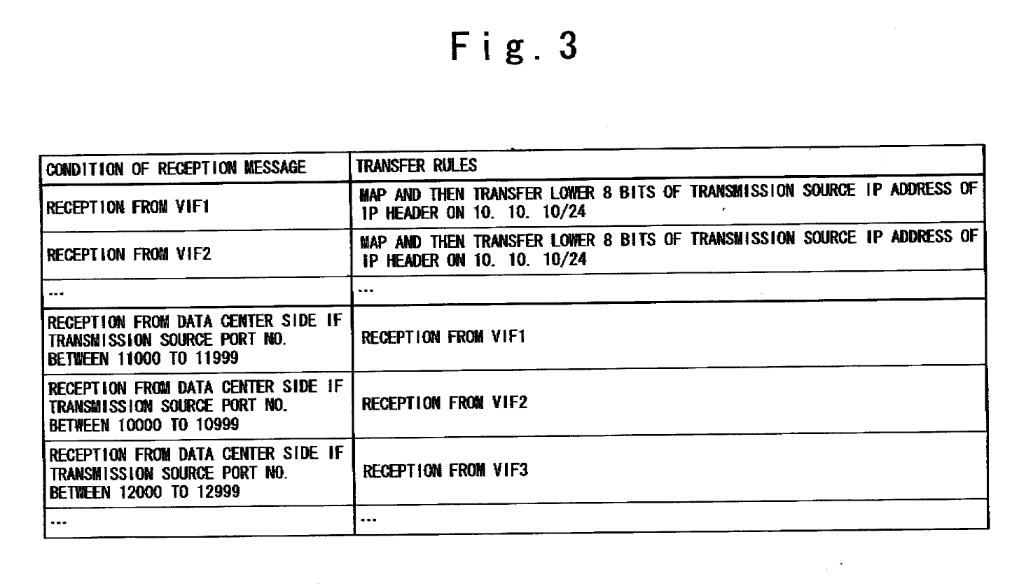

A VPN gateway 400 is provided between the public network 500 and the data center network 600, and carries out a terminating process of the VPN tunnels. The VPN gateway 400 includes a VPN side interface (IP) 420 connected to the public network, and a data center side IP 430 connected to the data center network 600. The VPN side IF 420 virtually further includes a plurality of IFs (virtual interfaces (VIF)) 421-i (i is an integer of 1 to n), and each VIF is connected to the private network 300 through the VPN tunnel. A VPN terminating section 410 has a function of carrying out the terminating process of the VPN tunnels. In addition, the VPN terminating section 410 has a function of carrying out an address conversion process on a packet received from the private network 300-1 through the VPN tunnel by referring to a packet transfer rule shown in FIG. 3 to transfer it to the data center network 600. Also, the VPN terminating section 410 has a function of transferring a packet received from the data center network 600 to the private network 300 based on a header data.

Meanwhile, the client group in terms of the application level is a group in which the correspondence relation between each client terminal and the group is defined in a group data managing server such as a groupware servers an employee data managing server, etc. Examples of the managed data in the group data managing server may be an identifier and the belonging group of each client terminal, and IP addresses and the like of the client terminals. There is no correspondence relation between the network to which the client terminal is connected and the client group. In other words, there may be a case where the client terminals belonging to different groups are connected to the same network.

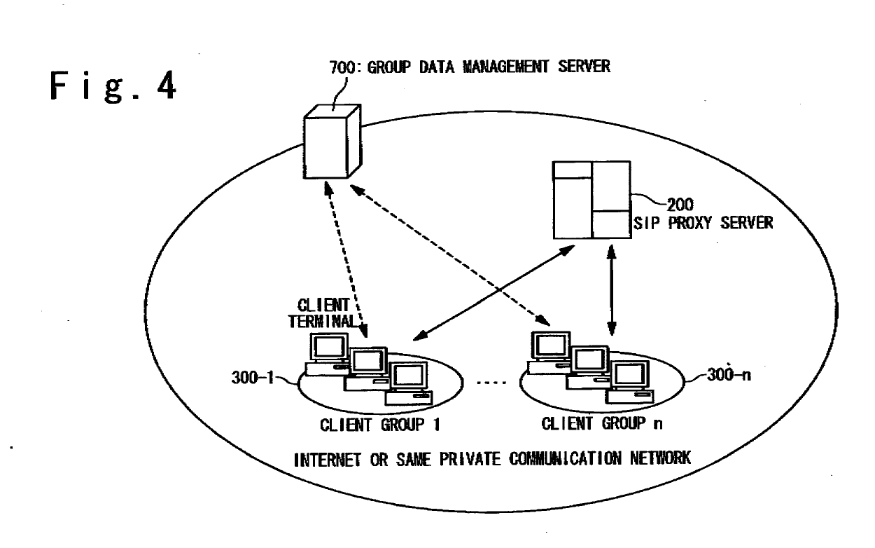

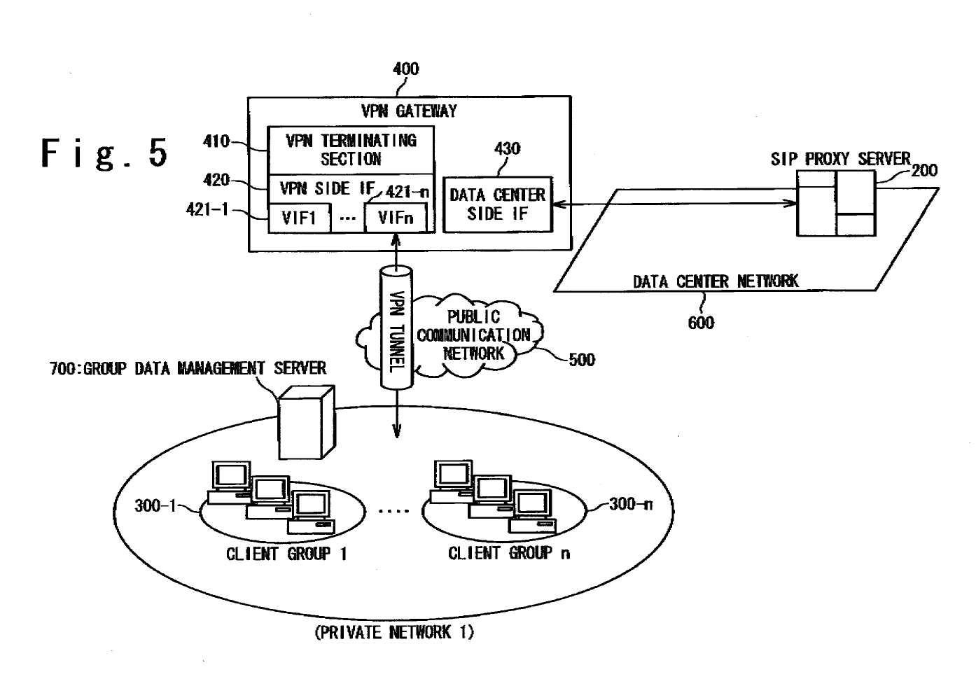

FIGS. 4 and 5 show examples of the network configuration when the client groups of the application level communicate with the SIP proxy server 200. In FIG. 4, the SIP proxy server 200 and the client terminals are connected to the Interne or the same private network, and the connections between the client terminals are secured no matter which of the client groups the client terminals belong to. Similarly, in FIG. 5, the client terminals are connected to the same private network, and the connections between the client terminals are secured no matter which of the client groups the client terminals belong to. It should be noted that there may be a case where the same client terminal participates in a plurality of client groups simultaneously, regardless of the forming method of the client groups.

The SIP server sharing module 100 carries out the relay process of the message such that the processes from (Process 2) to (Process 4), i.e. transfer of a message, register for receiving a data notification, and a response for the client terminal data inquiry, are not carried out between the client terminals that do not belong to the same client group. For example, regarding (Process 2), a call request, notification of the presence data, and chat message from a client terminal belonging to the client group A is not transferred to client terminals belonging to other client groups. Further, regarding (Process 3), a request, from the client terminal belonging to the client group A, for receiving the presence data of the client terminal belonging to another client group is not registered to the SIP proxy server 200. Regarding (Process 4), the SIP proxy server 200 does not respond to the inquiry from the client terminal belonging to the client group A for receiving the registered data of the client terminal belonging to another client group. Furthermore, a response message transmitted from the SIP proxy server 200 in response to a request message transmitted from a client terminal that belongs to a specific client group is not transmitted to the client terminals belonging to other client groups other than the specific client group.

By carrying out the message relay process as described above, the SIP server sharing module 100 provides security to each client group as if it is in use of the exclusive SIP proxy server 200, even though the SIP proxy server 200 is used in common by a plurality of client groups 300-i.

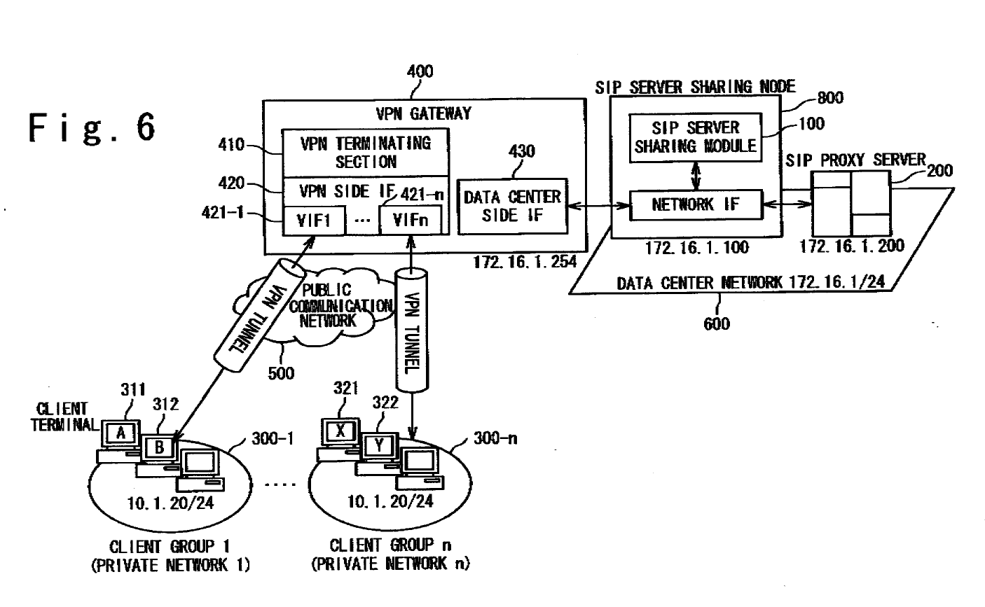

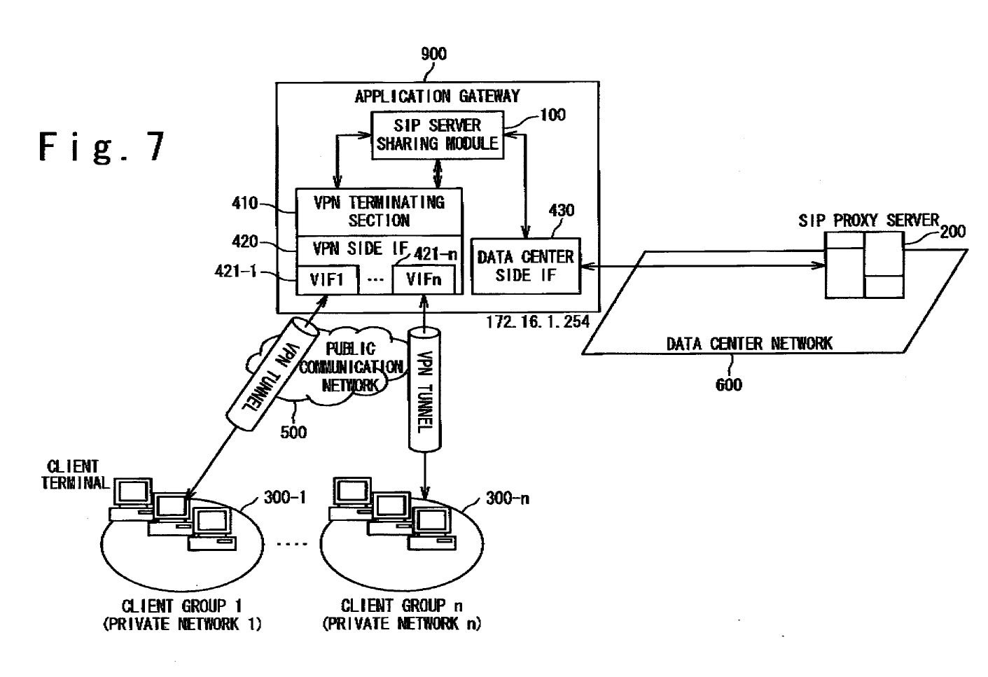

FIGS. 6 to 8 show examples of the layout forms of the SIP server sharing module 100. There are a form shown in FIG. 6 that the SIP server sharing module 100 is provided alone within a server machine (SIP server sharing node 800), a form shown in FIG. 7 that the SIP server sharing module 100 is provided in a same node 900 as the VPN gateway is provided to function as an application level gateway, and a form in FIG. 8 that the SIP server sharing module 100 is provided in a same node as the SIP proxy server 200 is provided. FIGS. 6 to 8 show the client groups of the network level, and any of the layout forms can be employed regardless of the forming method of the client groups.

The SIP server sharing module 100 includes a message source group identifying section 110, a group tag inserting/removing section 120, an address converting section 130, a message type determining section 140, and a message destination group identifying section 150. Each of those components will be described later.

Regarding a message transmitted from a client terminal, the message source group identifying section 110 identifies the client group to which the source client terminal belongs, and notifies it to the group tag inserting/removing section 120. Methods for identifying the client group differ depending on the configuration of the client group. When the client group is a group of the network level, a following method may be considered. That is, a source IP address of an IP header and a source port number of a UDP header (or a TCP header) of the message received from a client terminal are converted to different address regions for every VPN (every client group to which the client terminal belong) at the VPN terminating section 410 of the VPN gateway 400 or the application level gateway 900, and the message source group identifying section 110 determines the client group to which the source terminal of the received message belongs, from the converted source address or the source port number. It should be noted that the subjects of conversion are not limited only to the source IP address and the source port number but also other parameters of the IP header (for example, protocol number and the like), the port number or the like of the upper layers such as TCP (transmission control protocol) or UDP (user datagram protocol) header. However, it is not practical since the load of the conversion process is heavy when the header data of TCP or UDP in an upper level than IP is converted in the VPN terminating section 410.

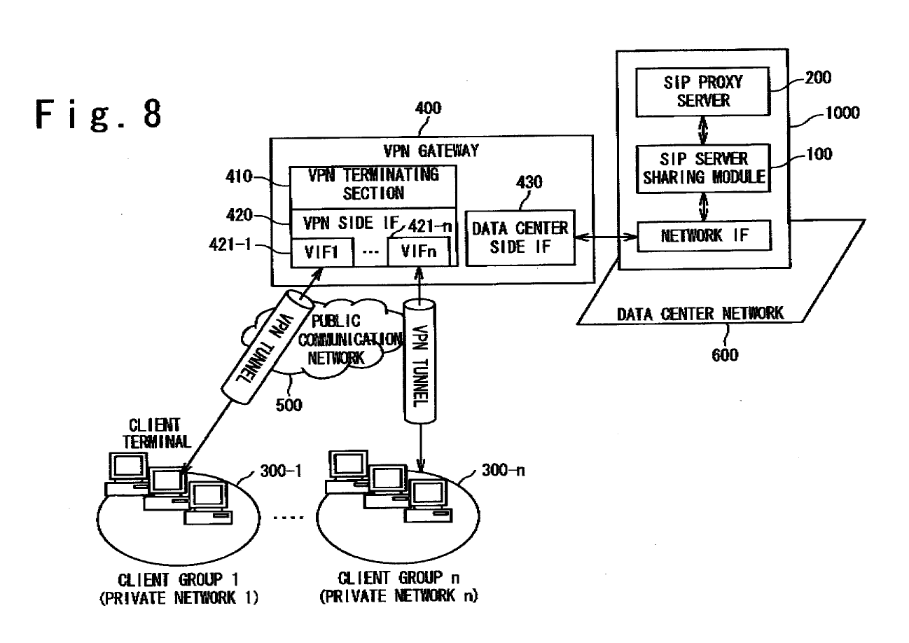

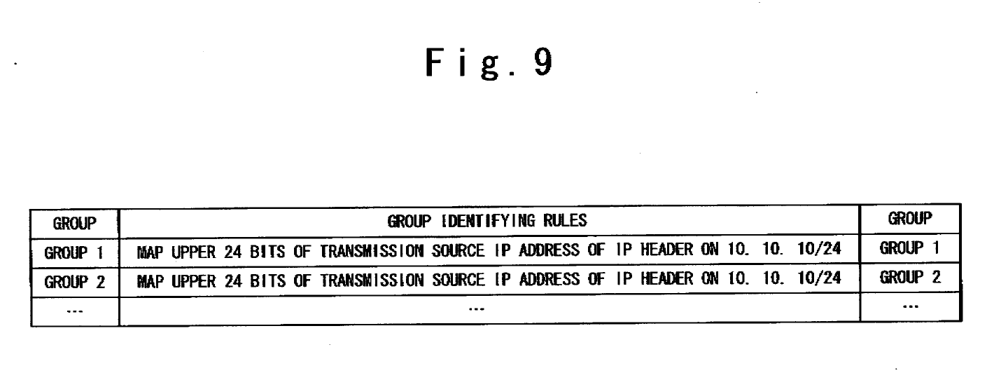

For employing this method, it is necessary to preset common rules between the VPN (virtual private network) terminating section 410 and the message source group identifying section 110 regarding which portion of the message (for example, the source address of the IP header) is to be converted, and which VPN (client group) is to be converted to which parameter region, as in examples that the client group 1 is converted to 10.10.10/24, the client group 2 is converted to 10.10.20/24. For example, when the VPN terminating section 410 uses the packet transfer rule shown in FIG. 3, it is necessary for the message source group identifying section 110 to have a table (referred to as a message source group identifying table) as shown in FIG. 9, to which the rules for identifying the source of the message are registered.

It should be noted that there is a case where a client terminal belongs to a plurality of client groups. In such a case, when the client group is a network level group, which of the client groups the SIP message from the client group is transmitted from can be specified uniquely. Therefore, in case of the network level client group, the message source group identifying section 110 always notifies a single client group to the group tag inserting/removing section 120 when receiving the SIP message.

In case of the application level client group, the message source group identifying section 110 carries out group identification in association with the group data managing server 700. Specifically, a method is considered that the message source group identifying section 110 inquires to the group data managing server 700 based on a user ID supplied from the client terminal when the client terminal and the SIP server sharing module 100 exchange the SIP message, for example. A method is considered that when a client terminal carries out SIP digest authentication, the message source group identifying section 110 makes an inquiry about the client group to which the client terminal belongs to the group data managing server 700 based on the user ID presented in the digest authentication. Further, when the client terminal corresponds to SIPS (Strategic Internet Professional Service) that exchanges SIP messages through SSL (Secure Socket Layer), a method is also considered that the user ID is extracted from a client certificate supplied from the client terminal at the time of constituting the SSL connection, and the client group to which the client terminal belongs is inquired to the group data managing server 700 based on the extracted user ID.

When it is found that the client terminal belongs to a plurality of client groups as a result of inquiry to the group data managing server 700, the message source group identifying section 110 notifies all of the client groups to which the client terminal belongs. In other words, unlike a case of the network level client group, there may be a case where a plurality of client groups are notified to the group tag inserting/removing section 120 when the message source group identifying section 110 receives the SIP message in case of the application level client group.

The group tag inserting/removing section 120 is composed of two modules, i.e. a group tag inserting section 121 for inserting a group tag to a SIP message that is transmitted from the client terminal, and a group tag removing section 122 for notifying the group tag contained in the SIP message transmitted from the SIP proxy server 200 to the message source group identifying section and removing the group tag from the SIP message. Each of the modules will be described later.

Into a SIP message transmitted from a client terminal, the group tag inserting section 121 inserts a group tag corresponding to the client group to which the client terminal as the source of the SIP message belongs, based on the client group notified from the message source group identifying section 110. Further, when it is found that the SIP message transmitted from the client terminal is a request message as a result of an inquiry to the message type determining section 140, the IP address of the SIP server sharing module 100 and the port number used for waiting for the SIP are added to the via header so that the SIP server sharing module 100 can intercept a response message which is transmitted from the SIP proxy server 200 in response to the request message.

It should be noted that when there are a plurality of client groups notified from the message source group identifying section 110, one of the following processes will be carried out. Copies of the SIP message transmitted from the client terminal are produced for the number of the notified client groups, and the group tags corresponding to the notified client groups are inserted to the respective copies. The group tags corresponding to the client groups that are notified from the message source group identifying section 110 are all inserted into the SIP message transmitted from the client terminal. After inserting the group tags, the SIP message is transferred to the address converting section 130. There are two methods for inserting the group tag depending on an inserting position of the group tag. The first one is a method that the group tag is inserted into SIP URI contained in the SIP message, and the second one is a method that the group tag is inserted into a portion other than the SIP URI. (

First Method)

Regarding the SIP URI, in case of the URI of sip: UserD: passwd@west.net: 5060, according to a format of “sip (or sips)”: “user identifier”: “password” “@” “host or domain space”; “port number”: “other data”, “UserD” corresponds to the user identifier, “passwd” to the password, “west.net” to domain space, and “5060” to the port number that the client terminal uses for waiting for the SIP (in this example, there is no section corresponding to “other data”. The password, port number, and other data are omitted in many cases). In the first method, the group tag inserting section inserts the group tag into the user identifier section of the components of the SIP URI. A method may be considered in which the group tag is inserted into other sections than the user identifier section, such as the host, domain space, or the other data section. However, these sections may not be registered to the database depending on the mount state of the server. Thus, this method is not desirable. There is a case where these sections are omitted when a portion of “host or domain space” of the section before “@” is not a domain space and the host is designated based on the IP address or FQDN (Fully Qualified Domain Name). In such a case, the first method is not employed to insert the group tags.

Normally, a plurality of SIP URIs are written into the SIP message. The group tag inserting section 121 inserts the group tags to all the SIP URIs contained in the header section of the SIP message. There is a case where the SIP URI is written into a body section of the SIP message. However, the body section is a part that is not basically used in a transfer process carried out by the SIP proxy server 200. Therefore, it is unnecessary to insert the group tag to the SIP URI that is written into the body section.

When the SIP message transmitted from the client terminal is a method request message, e.g. INVITE, ACK, BYE, CANCEL, OPTIONS, REGISTER, SUBSCRIBE, NOTIFY, PUBLISH, and so on, the group tag is inserted to all of the request URI contained in the start line (request line) of the header section of the IP message, and the URIs that are designated by From header, To header, Contact header, and so on. Meanwhile, when the SIP message is a response message such as 100Trying, 180Ringing, or 200OK, which does not contain the method in the start line, the group tag is inserted only to the URIs that is designated by the From header, To header, Contact header and so on.

Next, specific examples of inserting the group tag will be provided in the followings.

For example, when the client terminal A of the client group 1 transmits a REGISTER message with the SIP URIs with the following From header, To header, and Contact header:

From: sip: UserA@here.com

To: sip: UserA@here.com

Contact: sip: UserA@4.3.2.1,

The group tag inserting section insets the group tag to each header of the request message in the following manner.

From: sip: UserA-group1@here.com

To: sip: UserA-group1@here.com

Contact: sip: UserA-group1@4.3.2.1,

As a result, not the original SIP URI UserA@here.com but the SIP URI “UserA-group1” (or UserA-group1@here.com), to which the group tag is inserted by the group tag inserting section 121, is registered to the SIP proxy server 200. Which of “UserA-group1” or “UserA-group1@here.com” to be registered depends on the mount state of the SIP proxy server 200. Even if a client terminal belonging to another client group other than the client group 1 transmits a request message such as INVITE message or BYE message in which UserA@here.com is designated as a message destination in the To header of the SIP message, the entry (UserA-group1@here.com) of the client terminal A is not hit because the group tag inserting section 121 inserts a group tag different from “group-1” to the URI. Thus, when the SIP proxy server 200 receives the SIP message form the outside the group, an error message (a response message in which a status code “404 Not Found” is written) is returned to the client terminal, to indicate that there is no SIP URI that corresponds to all the processes from (Process 2) to (Process 4) described above.

For example, when a client terminal X of the client group 2 transmits an INVITE message with the SIP URIs of the following From header, To header, and Contact header,

From: sip: UserX@here.com

To: sip: UserA@here.com

Contact: sip: UserX@5.6.7,8,

The group tag inserting section 121 inserts the group tag to each header of the request message in the following manner,

From: sip: UserX-group2@here.com

To: sip: UserA-group2@here.com

Contact: sip: UserX-group2@5.6.7.8

As a result, the SIP proxy server 200 searches the contact address of the message transfer destination based on “UserA-group2”. Thus, the entry (UserA-group1) of the client terminal A is not hit and an error message is returned to the client terminal X.

As described above, in the first method, the SIP proxy server 200 carries out the error process on the messages transmitted from the terminals out of the group for all the messages in the above-described (Process 2) to (Process 4), so that the messages are not transferred to those client terminal. Thus, the security within the group can be ensured. Further, regarding the process of (Process 1), even if the client terminal X of the group 2 transmits a REGISTER message pretending to be the client terminal A of the group 1, for example, it is possible to prevent a misjudgment since the SIP URI “UserA-group2@here.com” is registered to the SIP proxy server 200. At that time, “UserA-group1@here.com” is registered as the SIP URI of the client terminal A, so that the client terminals of the group 1 can designate the client terminal A by using the SIP URI “UserA@here.com”.

However, there are the following problems in the first method. When a client terminal participates in a new client group, the entries registered based on he REGISTER massage and SUBSCRIBE message transmitted before participating in the new client cannot be referred from the new client group. In other words, the SIP message from another client terminal within the client group cannot be transferred to this client terminal by using the entries that have been registered to the SIP proxy server 200 by the REGISTER message and SUBSCRIBE message before participating in the client group. Thus, it is necessary to retransmit the REGISTER message and SUBSCRIBE message every time the client terminal participates in a new client group. Furthermore, the entries registered to the SIP proxy server 200 based on the REGISTER message and SUBSCRIBE message that are transmitted from the client terminal before participating in the new group are valid until they are expired. Thus, unless explicitly deleting those entries, it is possible for the SIP messages transmitted from client terminals out of the group to be transmitted to this client terminal for a specific period even after this client terminal participates in the new group.

As described above, by the first method alone, it is possible to prevent the request messages of (Process 2) to (Process 4), which are transmitted from the outside the client group, from being transferred to the client group from the SIP proxy server 200. However, an additional device is required or preventing a response message transmitted from the SIP proxy server 200 in response to the request message from the outside the client group from being transferred to the client group. That is, it is not possible to prevent, by the first method alone, the response message that is transmitted from the SIP proxy server 200 in response to the request message from the client group 1, from being transmitted to the client group 2. Transfer of such a response message to the outside the client group can be prevented by the message destination group identifying section 150.

(Second Method)

In the second method, the group tag is inserted into any of the parameters contained in the SIP message that satisfy the following three conditions.

(A) Parameter containing no SIP URI.

(B) Parameter that is not deleted in the transfer process carried out by the SIP proxy server 200.

(C) Parameter in which a same value is written in the request message and the response message that is transmitted from the SIP proxy server 200 upon receiving the request message.

When the SIP server sharing module 100 receives the request message from the SIP proxy server 200 as a result of insertion of the group tag into the parameters satisfying the condition (B), it is possible to know which of the client groups the request message is transmitted from, or whether the request message is transferred from the SIP proxy server 200. As a result, the request message transferred from the SIP proxy server 200 can be transmitted to the client group to which the client terminal as the source of the request message belongs. That is, it is possible to prevent the request message from being transferred to the client terminals belonging to the client groups that are different from the client group to which the client terminal as the source of the request message belongs.

When the SIP server sharing module 100 receives the response message from the SIP proxy server 200 as a result of insertion of the group tag to the parameters satisfying the condition (C), it is possible to know which of the client groups the request message to the response message is transmitted from. As a result, the response message to the request message can be transferred to the client group to which the client terminal as the source of the request message belongs. That is, it is possible to prevent the response message from being transferred to the client terminals belonging to the client groups that are different from the client group to which the client terminal as the source of the request message belongs.

As the parameters that satisfy the above-described three conditions, Call-ID headers, Record-Route headers, Via headers, and so on are listed. It should be noted that in case of messages such as PUBLISH message, etc. of the SIP messages, which are transmitted from the client terminal to the SIP proxy server 200 for an issue of the presence data, the group tag is also inserted into the body section of the message where the presence data is written, in addition to inserting the group tag into the parameters that satisfies the above-described three conditions. This prevents the presence data from being notified to the outside of the group to which the issuing client terminal belongs (the details will be described later). For extending the body section, it is necessary to rewrite Content-Length field and Content-Type field of the header section.

Next, an example of inserting the group tag by the second method will be described below.

When the client terminal A belonging to the client group 1 transmits a call to a client terminal B belonging to the same client group 1, a tag “group-1” is inserted into the Call-ID header of the INVITE message that is transmitted from the client terminal A to the SIP proxy server 200. As a result of the transfer process in (Process 2) described above, the tag “group-1” is also inserted to the Call-ID header of the INVITE message that is transmitted from the SIP proxy server 200 to the client terminal B. Thus, the message destination group identifying section 150 determines that the message should be transmitted to the group 1, so that the message is transferred to the client terminal B.

Meanwhile, when the client terminal X belonging to the client group 2 transmits a call to the client terminal B belonging to the client group 1, a tag “group-2” is inserted to the Call-ID header of the INVITE message that is transmitted from the client terminal X to the SIP proxy server 200. In this case, the tag “group-2” is also inserted to the Call-ID header of the INVITE message that is transmitted from the SIP proxy server 200 to the client terminal B. Therefore, the message destination group identifying section 150 determines that the INVITE message should be transmitted to the group 2. Thus, the message is not transferred to the client terminal B that belongs to the client group 1.

In the second method, the original SIP URI contained in the REGISTER message and the SUBSCRIBE message transmitted from the client terminal is registered to the SIP proxy server 200 as it is. The SIP proxy server 200 carries out the transfer process of the message by using the original SIP URI. As a result, the SIP URI registered to the SIP Proxy server is not changed even after the client terminal participates in or leaves from the client group. Therefore, unlike the first method, it is unnecessary in the second method to retransmit the REGISTER and SUBSCRIBE message every time the client terminal participates in a new group. Furthermore, the SIP message from members outside the client group is not transferred from the time of participation, even though the data that has been registered to the SIP proxy server 200 before participating in the new group is not deleted explicitly or the REGISTER and SUBSCRIBE messages are not retransmitted after participating in the client group.

Meanwhile, in the second method, the entries registered to the SIP Proxy server can be referred from the client terminals outside the client group. Thus, the processes of (Process 3) and (Process 4) described above are carried out also on the request message from a client terminal outside the client group. For example, when a client terminal belonging to the client group 2 transmits an OPTION message of (Process 4) to the SIP proxy server 200 to obtain the registered data of a client terminal belonging to the client group 1, the OPTION message is processed by the SIP proxy server 200, and the registered data is notified to the client terminal that belongs to the client group 2.

The group tag removing section 122 searches and removes the group tag contained in the SIP message transmitted form the SIP proxy server 200, and notifies the removed group tag to the message destination group identifying section 150. The removal of the group tag is carried out with no relation of whether it is the request message or the response message. When the group tag is inserted to the body section of the SIP message in the second method, the Content-Type and Content-Length are also rewritten based on the removal result, in addition to removal of the group tag.

When the SIP message transmitted from the SIP proxy server 200 is a response message, the IP address and port number of the SIP server sharing module 100 inserted to the Via header of the response message are removed. Further, the contact address of the client terminal contained in the via header is set in the IP header and the UDP header of the response message, so that the response message is transferred to the client terminal.

The address converting section 140 converts the address of the SIP message, so that the SIP server sharing module 100 can intercept SIP messages transmitted from the SIP proxy server 200 to the client terminal, in particular, a request message. A response message of the SIP message is transferred inversely along the route through which the request message is transferred. The route through which the request message is transferred is written in the Via header of the header section of the SIP message, and the IP address and the port number of the SIP server sharing module 100 are recorded to the Via header by the group tag inserting section 121. Therefore, the SIP server sharing module 100 can intercept the response message even though the address converting section 140 does not perform any specific process.

Usually, when the SIP proxy server 200 transmits the request message to the client terminal, the request message is transmitted to the contact address of the client terminal that is registered in the process of (Process 1) described above. However, when the SIP proxy server 200 transmits the request message by designating the contact address of the client terminal as the destination address, there may be a case that the request message transmitted from the SIP proxy server 200 is transmitted directly to the client terminal without being transmitted through the SIP server sharing module 100, or a case that the request message is disposed at last without reaching the client terminal, depending on the layout form of the SIP server sharing module 100. In order to prevent such cases, the following two methods may be considered. One of the methods is to build a tunneling link between the SIP proxy server 200 and the SIP sharing module 100.

The tunneling link has such a character that a message, which is transmitted from a program that operates in one of two nodes between which the tunneling link is built, is necessarily transmitted to the other node. Examples of the tunneling link are such as an IPSEC tunnel mode and Ether Over HTTPS tunnel used in SOFTETHER, etc. Therefore, in the node where the SIP proxy server 200 operates, if a setting is carried out to transmit a message, namely, a SIP message with a port number (normally, UDP: 5060) used in SIP as a transmission destination port number among the messages transmitted from the own node, to the tunneling link regardless of the destination address, the SIP message transmitted from the SIP proxy server 200 is transmitted to the other end of the tunneling link, i.e., to the SIP sharing module 100, regardless of the transmission destination address.

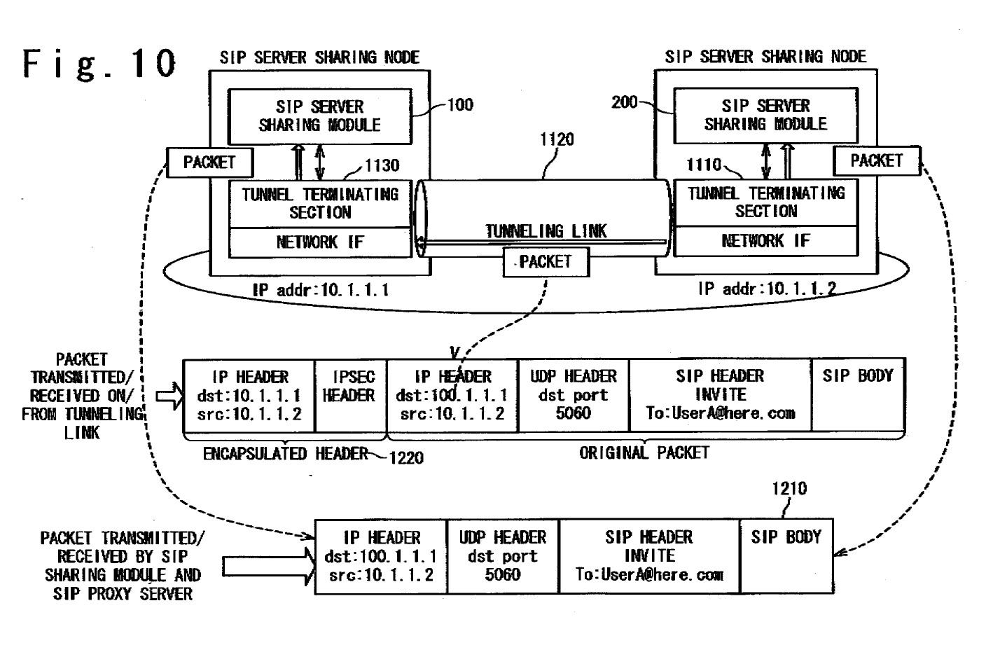

FIG. 10 shows an example of the tunneling link. FIG. 10 illustrates the INVITE message that is transmitted from the SIP proxy server 200 to a client terminal with a SIP URI of “UserA@here.com” and an IP address of “100.1.1.1”. The INVITE message 1210 transmitted from the SIP proxy server 200 has an encapsulated header 1220 added at the tunnel terminating section 1110 of the SIP proxy server 200 node, and is transmitted to the tunneling link 1220. It should be noted that the tunnel terminating section 1110 has a function of adding the encapsulated header 1220 to a packet (in this case, UDP packet whose transmission destination port number is 5060) which meets the condition (encapsulating), and of transmitting it to the tunneling link 1220, while having a function of removing the encapsulated header 1220 of the packet received via the tunneling link 1120 (decapsulating). In FIG. 10, an IPSEC tunneling mode is used as the tunneling link 1120, and an IPSEC header is added as the encapsulated header 1220. The tunnel terminating section 1130 of the SIP server sharing node upon receiving the packet via the tunneling link 1120 decapsulates the received packet and transfers it to the SIP server sharing module 100. Through utilizing the tunneling link as shown in FIG. 10, the SIP message transmitted from the SIP proxy server 200 is transmitted to the SIP server sharing node regardless of the transmission destination address. Therefore, it is possible to intercept the request message.

However, when carrying out interception of the request message by this method, the SIP proxy server 200 requires a setting for building the tunneling link. In addition, because all the SIP messages are basically transferred to the SIP server sharing module 100, the SIP proxy server 200 cannot transmit the SIP message to other SIP proxy servers 200. When interception is carried out by this method, the tunnel terminating section 1130 in the SIP server sharing node carries out building of the tunneling link and decapsulation of the SIP message. Thus, it is unnecessary for the address converting section 140 to perform any specific process.

The second method is a method (referred to as forward conversion hereinafter) in which the address converting section 140 converts the contact address (referred to as original address), that is the address which the client terminal requests the SIP proxy server 200 to register in the process of the above-described (Process 1) into an address which can be intercepted by the SIP server sharing module (referred to as intercept address hereinafter). The second method will be described in detail hereinafter.

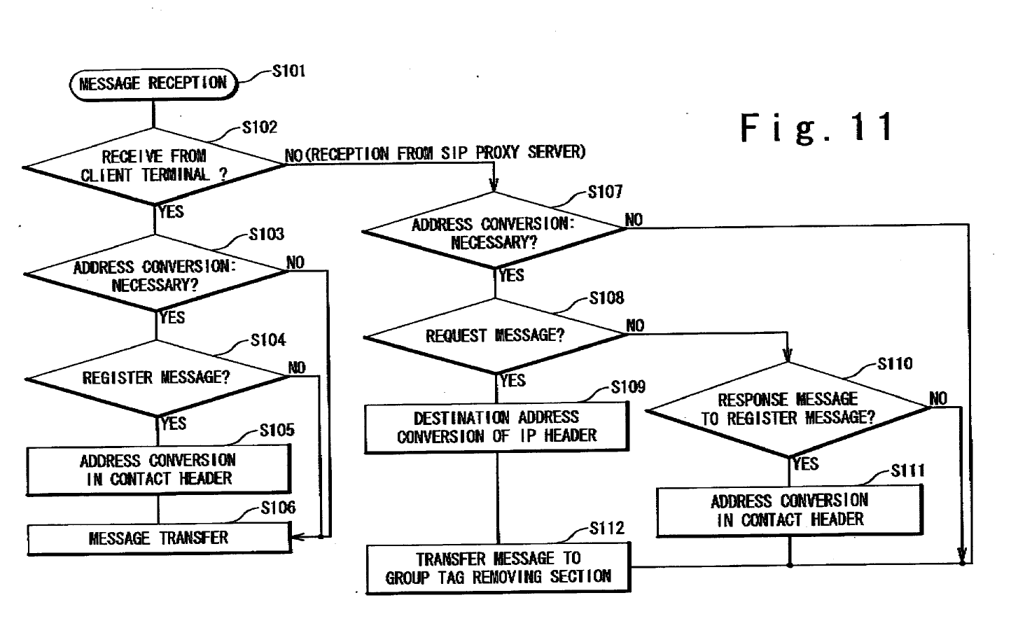

FIG. 11 shows a process flow of the address converting section 140 when the second method is employed. The process flow of the address converting section 140 will be described hereinafter by referring to FIG. 11.

(1) Step S101

The address converting section 140 receives a message.

(2) Step S102

When receiving the message, it is determined whether the massage is transmitted from the client terminal or the SIP proxy server 200.

(3) step S103

When it is determined that the message is transmitted from the client terminal, it is then determined whether address conversion is required or not. When the address conversion is not required, the message is transferred to the SIP proxy server 200 without carrying out any specific process (step S106).

When a tunneling link is built with the SIP proxy server 200, it is determined that address conversion is unnecessary. When the tunneling link is not built therewith, it is determined that the address conversion is unnecessary, provided that the IP address region allotted to the client terminal is known in advance, and the IP address region is included in the intercept address. Particularly, in case of a network level client group, it is determined that address conversion for the message transmitted from the client group and the message transmitted from the SIP proxy server 200 to the client group is unnecessary, provided that the IP address region allotted in advance to the client terminal belonging to a specific client group is known, and the address region is included in the intercept address. It is determined that address conversion is necessary in cases other than the above-described cases. The route of the message (from which group to which group the message is transmitted) is determined from the group tag inserted to the message.

(4) Step S104

When address conversion is required at step S103, it is determined whether the message is a REGISTER message or not, by issuing an inquiry to the message type determining section 140.

(5) Step S105

When it is the REGISTER message, the IP address or the port number (original address) contained in the Contact header in the header section is converted in the forward direction.

(6) Step S106

After the forward conversion, the REGISTER message is transmitted to the SIP proxy server 200.

(7) Step S107

Meanwhile, when it is determined at step S102 that the message is transmitted from the SIP proxy server 200, it is first determined whether address conversion is required or not. The basis of determination is the same as that of the case for process the message transmitted from the client terminal. When address conversion is unnecessary, the message is given to the group tag removing section 122 (step S112).

(8) Step S108

When address conversion is required, it is determined whether the message is a request message or not, by issuing an inquiry to the message type determining section 140.

(9) Step S109

When it is the request message, there is carried out the process (referred to as inverse conversion hereinafter) for converting the transmission destination address or the transmission destination port number of the IP header of the SIP from the intercept address into the original address. After the inverse conversion process, the message is given to the group tag removing section 122 (step S112).

(10) Step S110

When it is determined at step S108 that the message transmitted from the SIP proxy server 200 is a response message, it is determined whether or not the message is the response message for the REGISTER message, by issuing an inquiry to the message type determining section 140.

(11) Step S111

When it is the response message for the REGISTER message, the IP address or the port number contained in the Contact header is converted in the inverse direction to the original address, since the IP address or the port number has been converted into the intercept address.

(12) Step S112

Thereafter, the message is given to the group tag removing section 122.

At the time of carrying out the forward conversion and the inverse conversion, it is necessary for the process of both conversions to be carried out under a common rule. This rule is written in the address conversion table 131, which is referred at the time of carrying out the forward conversion and inverse conversion.

The following addresses (A)-(C) or address regions can be used as the intercept address. (A) IP address of the SIP server sharing module 100 itself.

This address region can be used as the intercept address regardless of the layout form of the SIP server sharing module 100. Following conversion methods may be considered.

(A-1) The correspondence relation between the SIP URI and the original address is stored in the address conversion table 131 at the time of forward conversion, and the intercept address is converted to the original address based on the URI of the intercepted address at the time of referring to the address conversion table 131 to carry out the inverse conversion. It is necessary in this method to store the relation between the URI and the original address for all the client terminals. Thus, the scale of the rules to be stored is increased in accordance with an increase in the number of the client terminals.

(A-2) When a plurality of addresses are allotted to the SIP server sharing module 100 itself, the rules for converting the original addresses and the intercept addresses are registered in advance to the address conversion table 131. For example, when all the IP addresses contained in the region of “133.1/16 (133.1.0.0-133.1.255.255)” are allotted to the SIP server sharing module 100, such a rule is registered in the address conversion table 131 that the lower sixteen bits of the original address are mapped onto the intercept address (that is, “133.1/16”). In case where the original address is “10.2.3.4”, the lower sixteen bits, i.e., “3.4” portion is mapped to convert the original address into the intercept address “133.1.3.4” through the forward conversion.

When the SIP server sharing module 100 receives a SIP message with the transmission destination address of “133.1.3.4”, the address is inversely converted to “10.2.3.4” by combining “3.4” portion of “133.1.3.4.” with the upper sixteen bits of the original address, i.e., “10.2” portion. In this case, under condition that the SIP message is received only from the client terminals having the IP address within the range of 10.2/16, it is only necessary to store such a conversion rule that “the upper sixteen bits of the IP address of the original address are always “10.2” and the lower sixteen bits are converted to the same values as those of the intercept address”, regardless of the number of the client terminals.

In case that the range of the IP address of the client terminal is broader than the range of the IP address (that is, the intercept address) allotted to the SIP server sharing module 100, when receiving a SIP message from a client terminal having the IP address with the range of 10/8, data of eight bits cannot be mapped to the IP address of the SIP server sharing module 100. For example, when the original address is converted to the intercept address “133.1.3.4” by mapping the lower sixteen bits, “x” portion of the original address “10.x.3.4” becomes unclear. In that case, there is considered such a method that the part of the original address, which cannot be mapped to the IP address of the SIP server sharing module 100, is mapped to the port number of the SIP server sharing module 100. The data of eight bits from the 9th bit to 16th bit cannot be mapped to the IP address in the above-described case, so that the SIP server sharing module uses the port number for the eight bits (for example, from 5060 to 5316 (=5060 +2−8)as the intercept address.

For example, when the original address “10.7.3.4: 5060” is converted in the forward direction, the lower sixteen bits, the “3.4” portion is mapped to the IP address to have the address “133.1.3.4”, and “7” portion (that is, the 9th-16th bits in the high-order of the IP address) is mapped to the port number to convert the port number to “5067”. The finally obtained address “133.1.3.4; 5067” is used as the intercept address. In this case, the conversion rule is that “the higher eight bits of the IP address of the original address is always 10, and the port number is 5060. The lower sixteen bits of the original address is mapped to the lower sixteen bits of the intercept address, and eight bits form the 9th-16th bits in the high-order are mapped to the range of the port numbers 5060-5316.

When the port number is also included as the subject of mapping, it is necessary for the SIP server sharing module 100 to be in the waiting state at a plurality of port numbers (5060-5316 in the above case) that are used as the intercept address.

(B) The address region where the node where the SIP proxy server 200 and the SIP server sharing module 100 is provided (referred to as a SIP message transfer node hereinafter) is connected to the same sub-net, and the IP address of the SIP message transfer node is set as a gateway address in the SIP proxy server 200.

For example, when the address of the SIP message transfer node is “10.0.0.254” (the sub-net region is “10.0.0/24”) and the gateway address regarding the address “10.1/16” is set as “10.0.0.254” (the address of the SIP message transfer node) in the SIP proxy server 200, all of the messages transmitted from the SIP proxy server 200 towards the addresses within the range of 10.1/16 are transferred through the SIP message transfer node. In this case, therefore, the address “10.1/16” is used as the intercept address.

When the original address is not within the range of the intercept address, address conversion is carried out through the same method as in (A-2) described above.

(C) Local Loop Backup Address (127/8)

This address region can be used when the SIP server sharing module 100 and the SIP proxy server 200 are in the same node physically (for example, the case of constitution shown in FIG. 8). Address conversion is carried out through the same method as in (A-2) described above.

Based on the group tag notified from the group tag removing section 122, the message destination group identifying section 150 identifies the client group to which the client terminal belongs, to which the SIP message transmitted from the SIP proxy server 200 is to be transferred, in order to prevent the SIP message from being transferred to the client terminal belonging to the client groups other than the intended client group. Thereby, it is possible to prevent the request message transferred from the SIP proxy server 200 and the response message transmitted from the SIP proxy server 200 from being transferred to the outside of the client group where the client terminal belongs as the source of the response message or the request message as the basis of the response message belongs. The specific contents of the process differ for the network level client group and the application level client group.

The following process is carried out when the client group is an application level group. That is, the message destination group identifying section 150 checks whether or not the client group identified as the destination of a SIP massage based on the group tag is coincident with the group to which the client terminal as the actual destination of the SIP message belongs, and transfers the SIP message to the client terminal only when it is confirmed to be coincident.

For finding the group to which the client terminal as the destination of the SIP message belongs, the client terminal as the destination of the SIP message is found out first, and then the client group to which the client terminal belongs is found out.

For finding the client terminal as the destination of the SIP message when the SIP message received from the SIP proxy server 200 is a response message, it can be obtained from the IP address or the host name written in the Via header of the response message. When the SIP message is a request message, the client terminal can be obtained from the transmission destination address written in the IP header of the SIP message.

As the method for finding out the client group to which the client terminal as the destination of the SIP message belongs, there is considered such a method that the client group is found by making an inquiry to the group data managing server using the IP address of the client terminal to be the destination of the SIP message, when the IP address of the client terminal and the client group to which the client terminal belongs are registered to the group data managing server.

Meanwhile, when the client group is a network level group, the message destination group identifying section 150 transmits the SIP message to a private network corresponding to the client group notified from the group tag removing section 122, In order to achieve this, it is necessary for the message destination group identifying section 150 to designate a transmission destination private network (the virtual IP to transmit the message) to the VPN terminating section by employing some kinds of methods. The specific methods differ depending on the layout form of the SIP server sharing module 100. For example, when the SIP server sharing module 100 and the VPN terminating section 410 are in the same node as shown in FIG. 7, the message destination group identifying section 150 transmits the SIP message by designating one of the virtual interfaces 421 provided for the respective VPNs in the VPN terminating section 410.

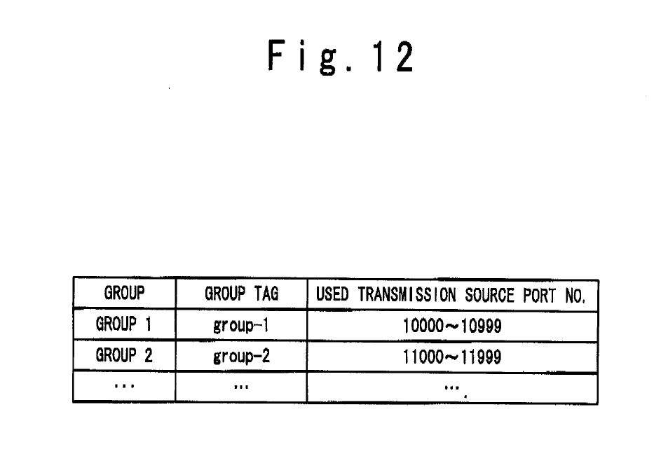

Meanwhile, when the VPN gateway 400 and the SIP server sharing module 100 are in the different nodes as shown in FIGS. 6 and 8, it is not possible for the message destination group identifying section 150 to designate one of the virtual interfaces 421 directly in the VPN terminating section 410. As a method for designating the transmission destination private network, there is considered a method in which the port number of the source of the SIP message transmitted to the VPN gateway 400 is notified while varying the values for each transmission destination private network. For example, when there are client groups from group 1 to group 3, the message destination group identifying section 150 selectively uses the source port numbers in accordance with the client groups (private networks) which are the transmission destinations of the SIP message, i.e., the message destination group identifying section 150 uses the source port numbers 10000-10999 for the message when the client group notified from the group tag removing section 122 is group 1, the port numbers 11000-11999 for the group 2, and the port numbers 12000-12999 for the group 3. FIG. 12 shows a setting example. A table carrying such settings will be referred to as a message destination group identifying table hereinafter. The same rules are also set in the packet transfer rule for the VPN terminating section 410 so as to transfer the messages from the source port numbers of 10000-10999 to the group 1 (to the private network corresponding to group 1), the messages from the port numbers of 11000-11999 to the group 2, and the messages from the port numbers of 12000-12999 to the group 3. FIG. 3 shows an example thereof. Through such settings, the SIP server sharing module 100 can designate, the private network to the VPN terminating section 410 to transmit the SIP message, even when the VPN gateway 400 and the SIP server sharing module 100 are in the different nodes.

It should be noted that when the SIP server sharing module 100 and the VPN gateway 400 are provided in different nodes as in FIGS. 6 and 8, it is necessary for the SIP message transmitted from the SIP server sharing module 100 to the client terminals to always go through the VPN gateway. As a method for achieving, there is considered a method which a tunneling link between the node where the VPN gateway 400 is provided and the node for which the SIP server sharing module 100 is provided (the SIP server sharing node in FIG. 6 or the SIP proxy server 200 node in FIG. 8) like a case of FIG. 10. It is so set in the node where the SIP server sharing module 100 is provided that, when the transmission message is the SIP message (i.e. when the source port number is 10000-12999 in the above-described case), the transmission message is transmitted to the tunneling link that is built between the client terminal and the VPN gateway 400.

The message type determining section 140 returns a type of message in response to an inquiry from the message destination group identifying section 150, the group tag inserting/removing section 120, and the address converting section 130. Type of the message indicates whether the message is a request message or a response message, a method of the message, a method of the response request message that triggers the response message, etc. The method of the request message can be determined by reading a method written in the CSeq header of the header section of the response message, which method of request message the response message corresponds to is written in the CSeq header of the response message.

Next, an operation example of the SIP server sharing module 100 according to the first embodiment will be described. The operation in case that the SIP communication network has the configuration of FIG. 6 will be described, unless there is any specific notice.

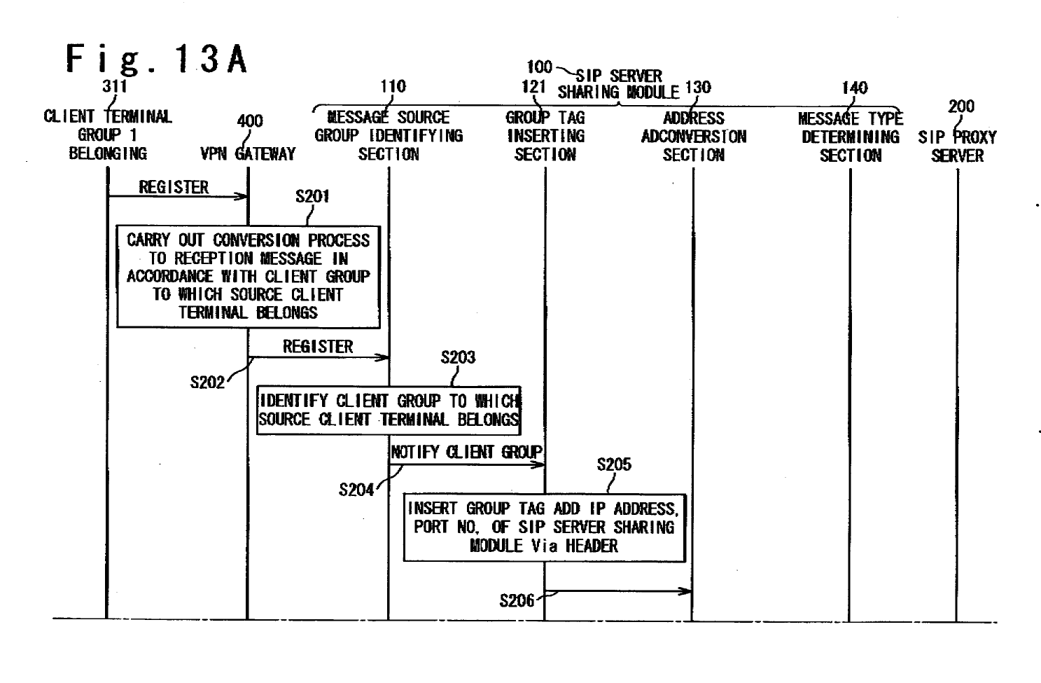

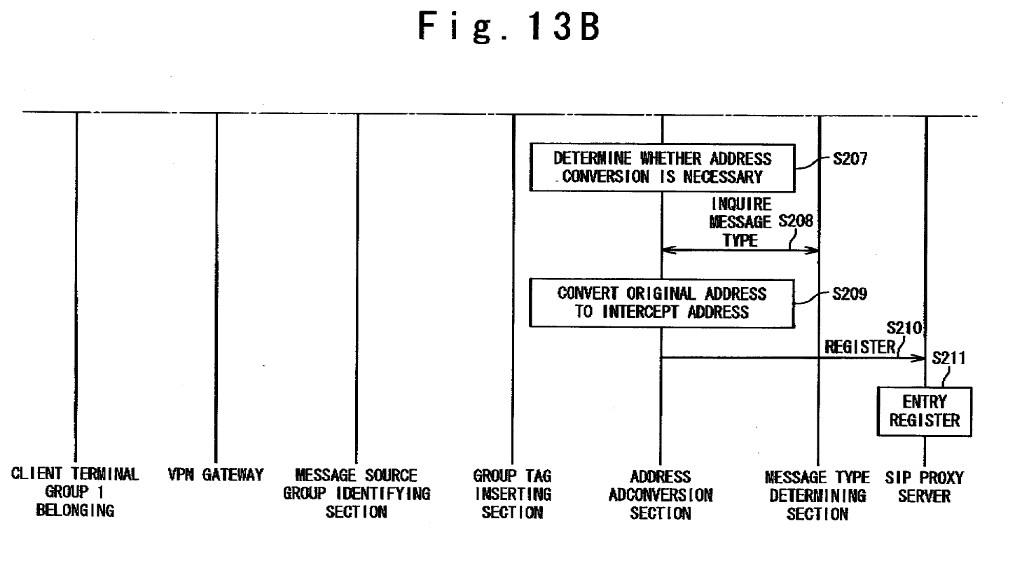

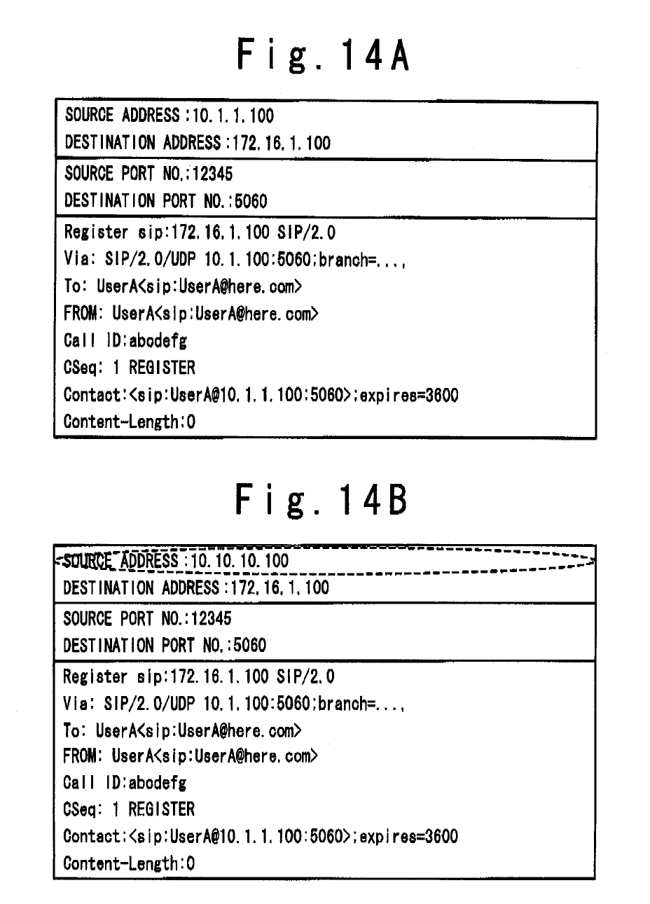

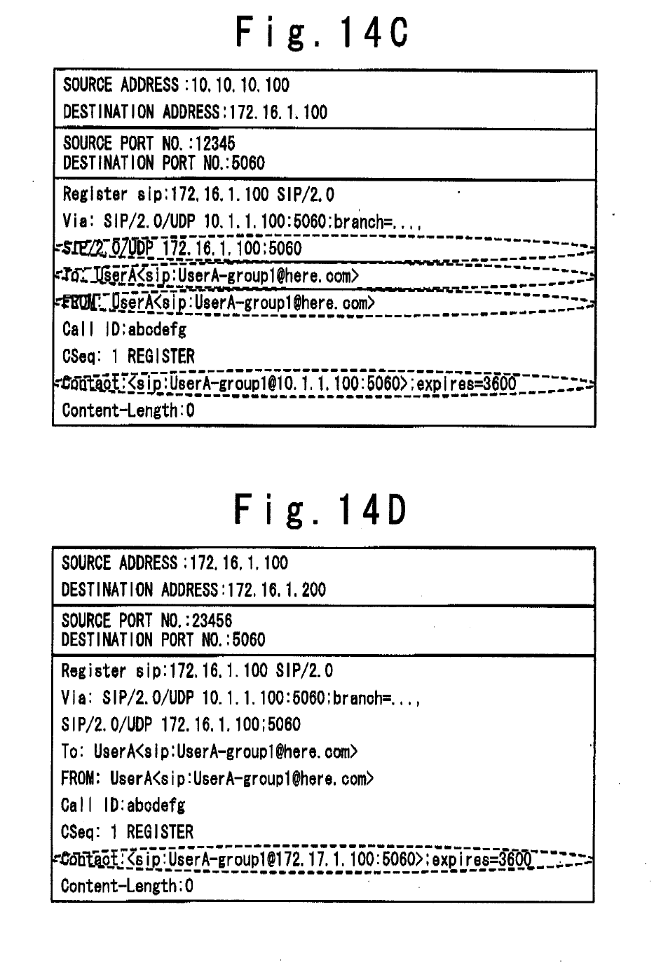

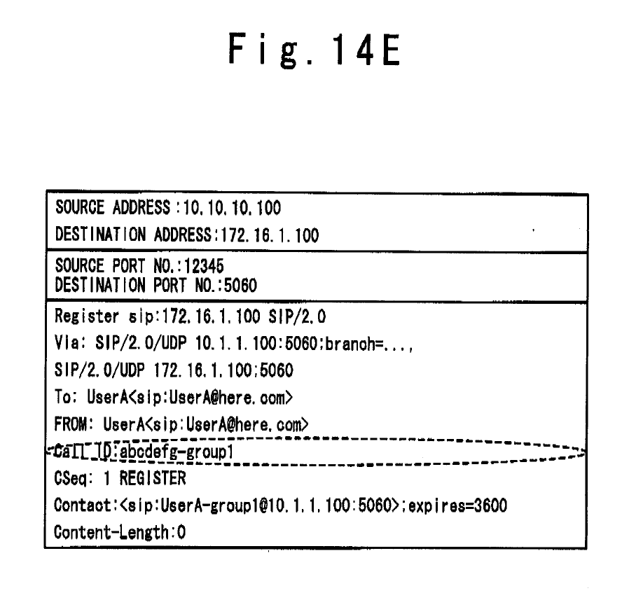

First, there will be described the operation for transferring a request message that is transmitted from the client terminal to the SIP proxy server 200 by referring to FIGS. 13A and 13B. FIGS. 13A and 13B shows a sequence when a client terminal A311 transmits a REGISTER message to the SIP proxy server 200 through the SIP communication network that has the configuration shown in FIG. 6. In the client terminal A311 (IP address “10.1.1.100”), the IP address (“172.16.1.100”, or the host name) of the SIP server sharing module 100 is set for the SIP proxy server 200, FIG. 14A shows the REGISTER message transmitted from the client terminal A311. The VPN gateway 400 carries out a relay process of the REGISTER message transmitted from the client terminal A311.

(1) Step S201

Upon receiving the REGISTER message from the client terminal A311, the VPN gateway 400 refers to a packet transfer rule and applies a conversion process on the received message so that when the SIP server sharing module 100 receives the REGISTER message later, the message source group identifying section 110 can identify the client group to which the client terminal as the source of the message belongs.

(2) Step S202

For example, when the packet transfer rule is set in the VPN gateway 400 as in FIG. 3, the VPN gateway 400 converts the source IP address in the IP header of the packet and then transfers the packet to the SIP server sharing module 100, In case of the message shown in FIG. 14A, the source IP address is converted by the VPN gateway 400 as shown in FIG. 14B. A part of the message circled within an oval with a dotted line in the drawing is converted to the source IP address (10.10.10.100) by the VPN gateway 400.

(3) Step S203

When the SIP server sharing module 100 receives the REGISTER message, the message source group identifying section 110 first refers to the message source group identifying table to identify the client group to which the source client terminal of the received REGISTER message belongs.

(4) Step S204

In the message source group identifying table, there is written a rule corresponding to the packet transfer rule so that the client group to which the message source client terminal belongs can be identified based on the process applied on the message by the VPN gateway 400. FIG. 9 shows the message source group identifying table corresponding to the packet transfer rule shown in FIG. 3. When the message shown in FIG. 14B is received, the source IP address is “10.10.10.100”. Thus, the message source group identifying section 110 identifies the client group as the client group 1 and notifies it to the group tag inserting section 121.

(5) Step S205

Upon receiving a data regarding the group to which the message source client terminal belongs, the group tag inserting section 121 inserts the group tag corresponding to that client group to the REGISTER message. Further, the group tag inserting section 121 adds the IP address (or the host name) of the SIP server sharing module 100 and the SIP waiting port number (can be omitted when using the default port number “5060”) to the Via header of the received message, so that the SIP server sharing module 100 can intercept the response message for the REGISTER message. FIG. 14C shows an example of the message after the group tag inserting section 110 carries out the above-described process on the message shown in FIG. 14B. The part of the message circled within ovals with dotted lines is a part processed by the group tag inserting section 121. In the example shown in FIG. 14C, the above-described first method is employed as the method for inserting the group tag.

FIG. 14E shows an example where the group tag is inserted by the second method. The part circled within an oval with a dotted line in the drawing is where the group tag is inserted. In the example shown in FIG. 14E, the group tag is inserted to the Call-ID header.

(6) Step S206

After inserting the group tag to the message, the message is given to the address converting section 130.

(7) Step S207

First, the address converting section 130 determines whether address conversion is necessary or not. For example, address conversion is unnecessary when the tunneling link is built between the SIP proxy server 200 and the SIP server sharing module 100 as shown in FIG. 10, or the original address is included in the region of the intercept address.

(8) Step S208

When determined that the address conversion is necessary, it is checked whether the message is a REGISTER message or not the by making an inquiry to the message type determining section 140,

(9) Step S209

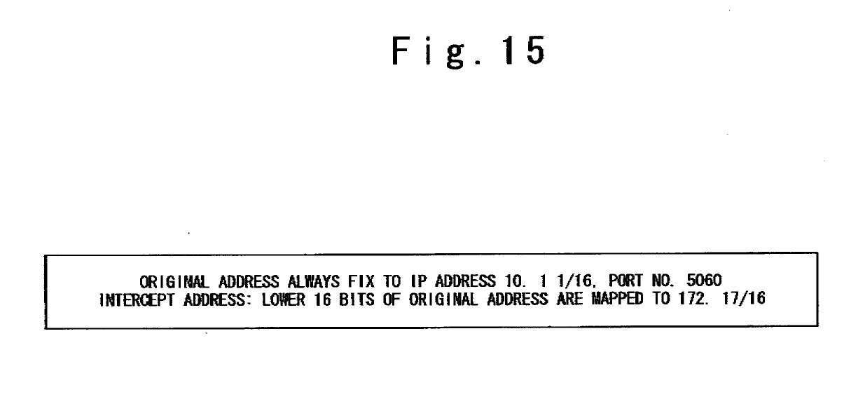

When the message is the REGISTER message, an original address contained in Contact header is converted in the forward direction by referring to the address conversion table 131. When the rule shown in FIG. 15 is registered to the address conversion table 131, the address converting section 130 carries out a forward conversion on the message as shown in FIG. 14D. The part circled within an oval with a dotted line in the drawing is the converted part.

(10) Step S210

After the address conversion is carried out, the REGISTER message shown in FIG. 14D is transmitted to the SIP proxy server 200.

(11) Step S211

Upon receiving the REGISTER message, the SIP proxy server 200 registers the SIP URI UserA-group1@here.com (the part after @ may be omitted in some cases) and “172.17.1.100” as the IP address corresponding to the URI.

When the first method is employed as the group tag inserting method as described above, even if a client terminal X321 belonging to a client group 2 300-2 transmits, after registration, a request message such as INVITE, OPTIONS, or SUBSCRIBE (UserA@here.com is designated in To header) towards the client terminal A311, the group tag is inserted to this request message by the group tag inserting section 121 and the To header is converted to UserA-group2@here.com. Therefore, the SIP proxy server 200 notifies the client terminal X321 that the SIP URI corresponding to the SIP proxy server 200 (returns a response message “404 Not Found”), and the processes of (Process 2)-(Process 4) described above are not carried out. That is, the processes of (Process 2)-(Process 4) described above are not carried out for the request message transmitted from the outside the client group.

Even if the client terminal X321 transmits the REGISTER message by misrepresenting the own URI as UserA@here.com to pretend as being the client terminal A311, a SIP URI is registered in the SIP proxy server 200 which URI is different from the SIP URI (UserA-group1@here.com.) which is registered based on the REGISTER message from the client terminal A311 having the URI of UserA-group2@here.com. For this reason, it is possible to prevent the client terminals outside the client group from being pretending as the terminals within the group with the request message.

Meanwhile, when the second method is employed as the group tag inserting method, the SIP URI UserA@here.com and the IP address “172.17.1.100” are registered to the SIP proxy server 200, when the group tag is inserted by the group tag inserting section 121 as in FIG. 14E. That is, registered is the original address where no group tag is inserted. Therefore, when the second method is employed, if the client terminal X321 belonging to the client group 2 300-2 transmits, after registration, a request message such as INVITE, OPTIONS, or SUBSCRIBE (UserA@here.com is designated in To header) towards the client terminal A311, the SIP proxy server 200 carries out the processes of (Process 2)-(Process 4), unlike the case of employing the first method, even though it is a request message transmitted from the outside the client group. Thus, regarding the process of (process 3), registration for notification of the data can be carried out even from the outside the client group. For example, when the client terminal X321 of the client group 2 300-2 requests registration for receiving notification of the presence data on the client terminal A311 of the client group 1 300-1, it is registered to the SIP proxy server 200 even though it is a registration request for a terminal outside the client group. However, the presence data of the client terminal A311 is not actually notified to the client terminal X321 as will be described later. That is, it should be noted that only the registration of the notification request is carried out. Further, regarding the process of (Process 4), data of the client terminal can also be obtained from the outside the client group.

However, even if the group tag is inserted by the second method and the SIP proxy server 200 carries out the processes of (Process 2)-(Process 4) on the request message from the outside the client group, the request message transmitted from the SIP proxy server 200 and the response message transmitted from the SIP proxy server 200 as a result of the process are not to be transferred to the client group other than the client groups that are the sources of this request messages. For example, the request message transmitted from the client terminal belonging to the client group 2 300-2 is not transferred to the client terminal belonging to the client group other than the client group 2 300-2, and the response message from the SIP proxy server 200 for this request message is not transmitted to the client terminal belonging to the client groups other than the client group 2. This will be described later.

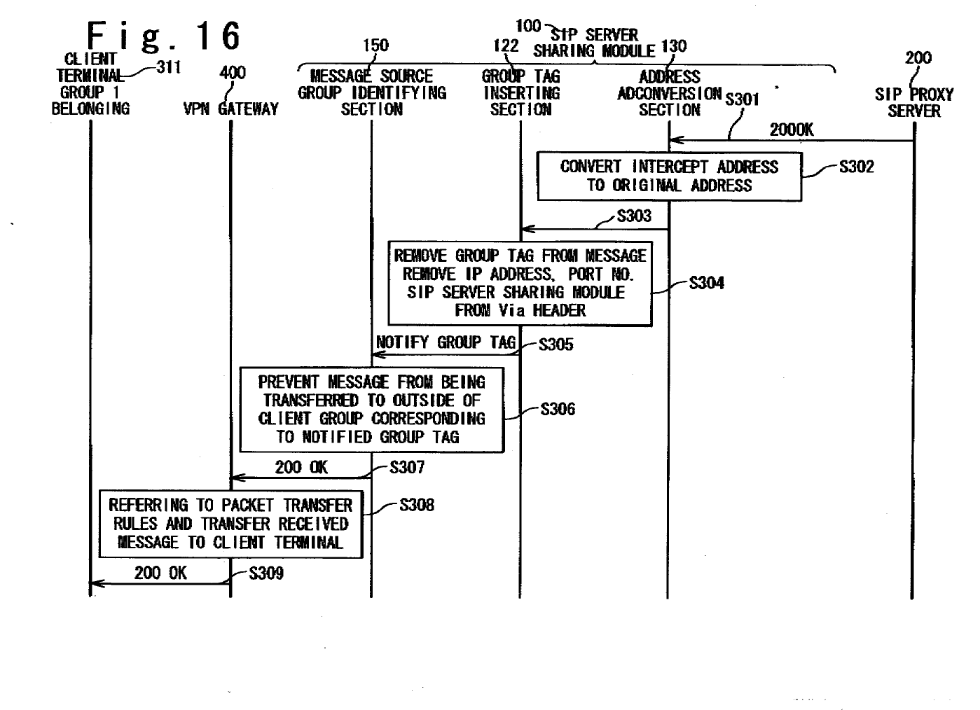

Next, an example will be described of the operation when the response message is transferred that is transmitted from the SIP proxy server 200 to the client terminal. FIG. 16 shows a case of transferring the response message for the REGISTER message as shown in FIG. 13A and FIG. 13B.

(1) Step S301

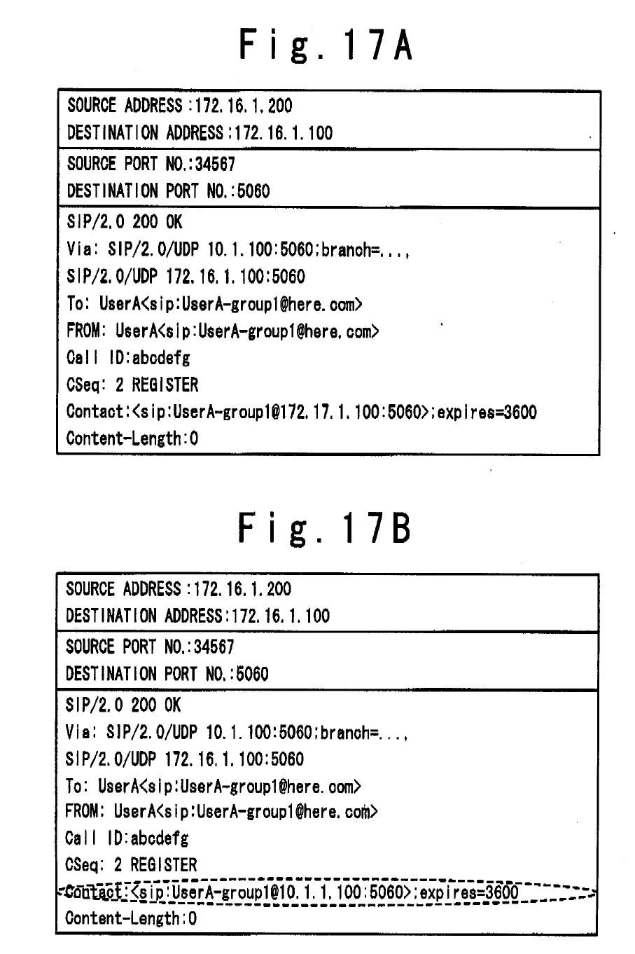

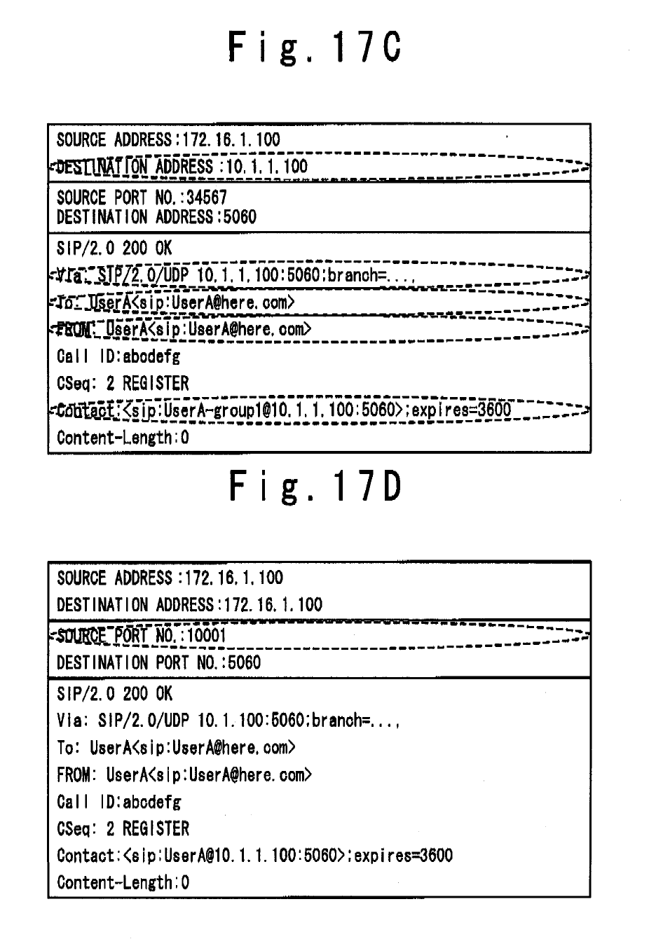

Upon receiving the request message, the SIP proxy server 200 transfers the response message for the request message inversely along the route that is written to the Via header. FIG. 17A shows an example of the response message transmitted from the SIP proxy server 200 when it receives the REGISTER message shown in FIG. 14D. The response message shown in FIG. 17A is transmitted to the SIP server sharing module 100.

(2) Step S302

When the SIP server sharing module 100 receives the response message, the address converting section 130 first carries out a message process. The address converting section 130 determines whether address conversion is necessary or not on the same basis for carrying out the forward conversion. When it is determined to be necessary, the address converting section 130 carries out inverse conversion by referring to the address conversion table 131 according to the flowchart shown in FIG. 11. When the response message shown in FIG. 17A is received, the message can be determined from the CSeq header of the message that the message is the response message for the REGISTER message. Thus, the IP address and the port number contained in the Contact header are converted from the intercept address to the original address, FIG. 17B shows a message obtained after the above-described process is carried out on the message shown in FIG. 17A. The part circled within an oval with a dotted line in the drawing is where the address converting section 130 carried out the conversion.

(3) Step S303

After the conversion process, the message is transferred to the group tag removing section 122.

(4) Step S304

The group tag removing section 122 removes the group tag inserted to the supplied message. Further, the group tag removing section 122 removes the IP address and the port number of the SIP server sharing module 100 contained in the Via header of the response message. Furthermore, the group tag removing section 122 sets the IP address and port number of the client terminal contained in the Via header to the transmission destination IP address of the IP header of the message and the transmission destination port number of the UDP header.

(5) Step S305

After carrying out the above process, the group tag is given to the message destination group identifying section 150. FIG. 17C shows a result after the group tag removing section 122 has carried out the process on the message shown in FIG. 17B. The parts circled within ovals with dotted lines in the drawing are where the group tag removing section 122 carried out the process.

(6) Step S306

The message destination group identifying section 150 identifies the client group as the message destination from the notified group tag, and carries out the message process thereon by referring to the message destination group identifying table to prevent the message from being transferred to the outside the client group corresponding to the group tag. For example, when the table shown in FIG. 12 is held as the message destination group identifying table, the source port number in the UDP header of the message in FIG. 17C is converted to the port number that is allotted to the client group 1. FIG. 17D shows a message after the conversion. The part circled within an oval with a dotted line in the drawing is the converted part.

(7) Step S307

After carrying out the message process, the message is transmitted to the client terminal.

(8) step S308

The message transmitted from the message destination group identifying section 150 to the client terminal is relay-processed by the VPN gateway 400. The VPN gateway 400 determines which virtual interface the message should be transmitted from by referring to the packet transfer rule.

(9) Step S309

For example, when the packet transfer rule shown in FIG. 3 is being set, the VPN gateway 400 determines when receiving the message shown in FIG. 17D that the massage should be transmitted from the virtual interface 1 based on the source port number. Thus, the VPN gateway transmits the message of FIG. 17D from the virtual interface 1.

The same group tag as that of the request message that is a trigger of the response message is inserted to the response message transmitted from the SIP proxy server 200 (no matter whether the group tag inserting method is the first method or the second method). Therefore, the process of the message destination group identifying section 150 makes it possible to prevent the response message from being transferred to the client group that is different from the client group to which the client terminal as the source of the request message belongs.

FIG. 16 shows a case where the group tag is inserted by the first method. However, the following process is carried out when the group tag is inserted by employing the second method. For example, when the group tag is inserted into the Call-ID, the same Call-ID as that of the request message that is a trigger of he response message is used for the Call-ID of the response message (it is defined so in RFC). Thus, the same group tag as that inserted into the Call-ID of the request message is inserted to the response message. Therefore, when the message destination group identifying section 150 transfers the response message to the client group corresponding to the group tag, it is possible to prevent the response message from being transferred to the client group that is different from the client group to which the client terminal as the source of the request message belongs.

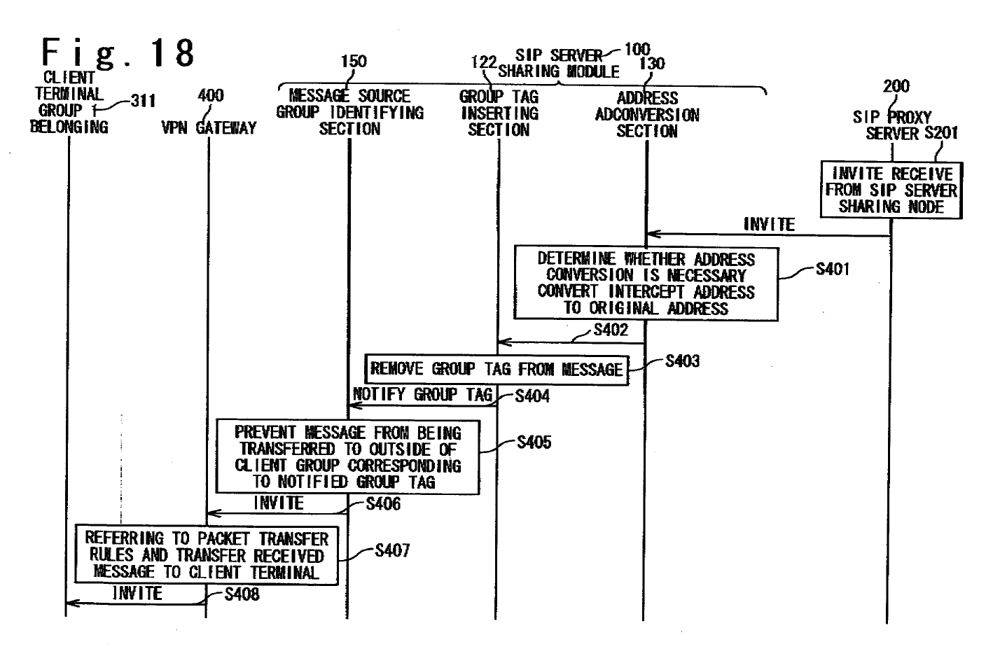

Next, the operation of the SIP server sharing module 100 will be described when the request message that is transmitted from the SIP proxy server 200 to the client terminal is transferred. FIG. 18 shows an operation example at the time of transfer. FIG. 18 shows the operation when a client terminal B 312 belonging to the client group 1 300-1 transmits an INVITE message to the client terminal A 311. The INVITE message is transmitted from the client terminal B 312 to the client terminal A 311 via the SIP proxy server 200. In FIG. 18, the sequence for transmitting the INVITE message from the client terminal B 312 to the SIP proxy server 200 is omitted.

(1) Step S401

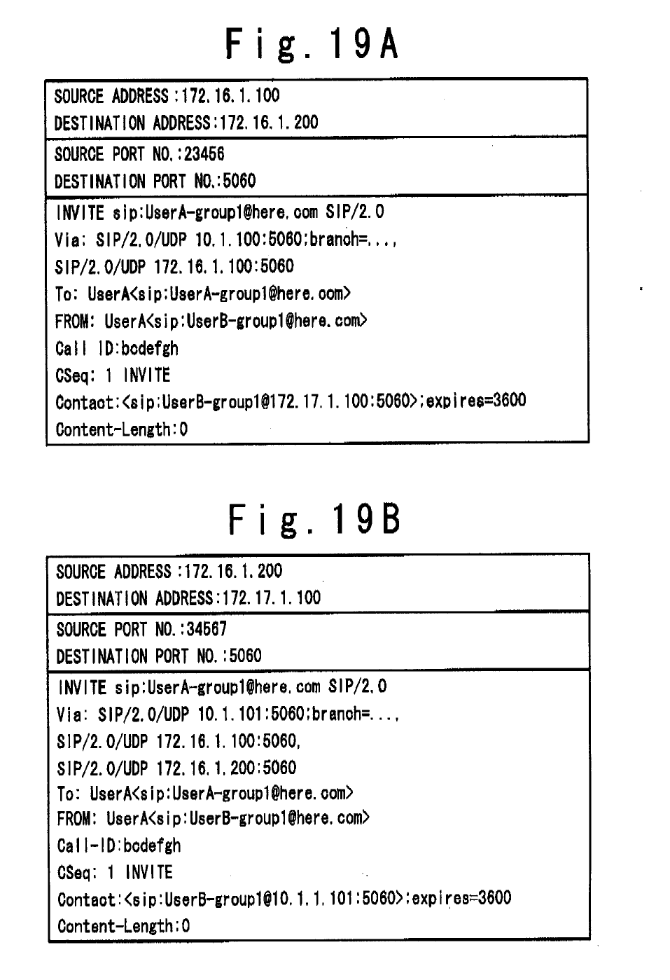

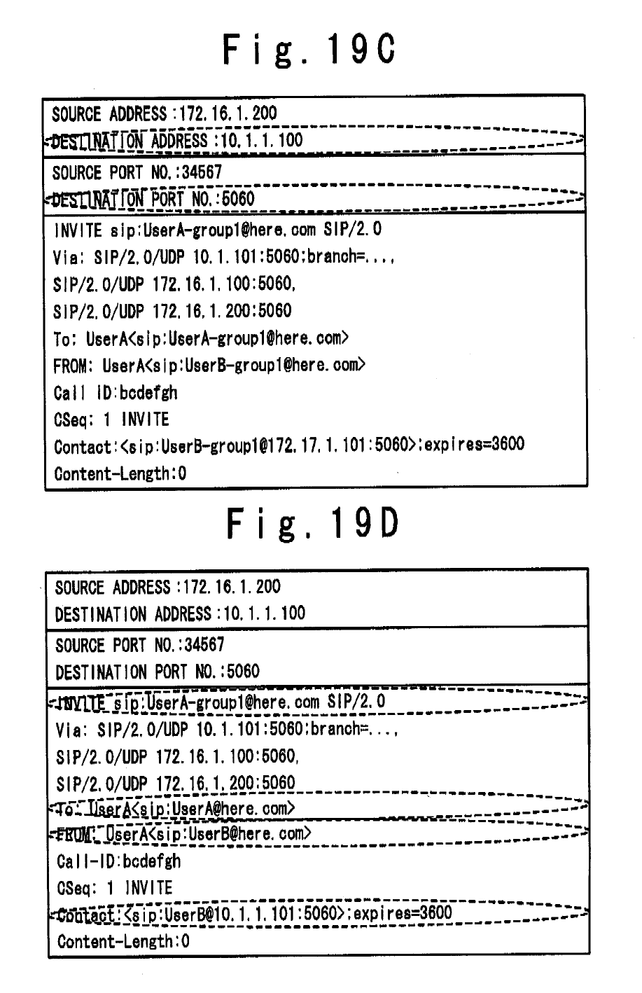

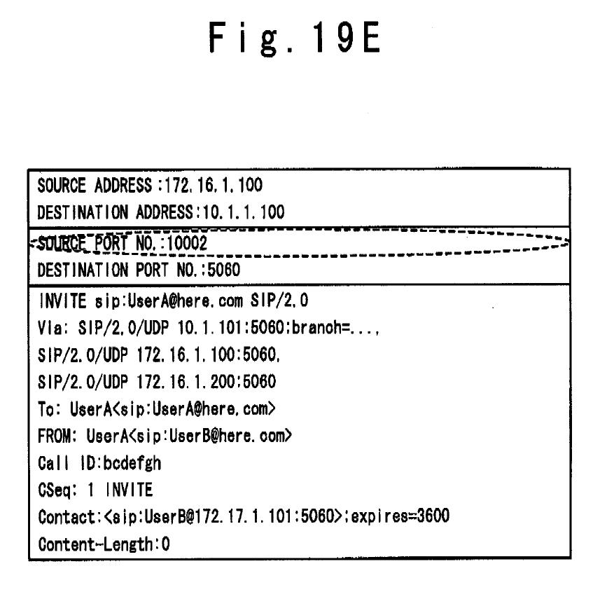

When the SIP server sharing module 100 receives a request message from the SIP proxy server 200, the address converting section 130 first carries out the process on the message. The address converting section 130 determines whether inverse conversion of the address is necessary for the received request message. When it is determined to be necessary, the address converting section 130 carries out the inverse conversion to return the transmission destination address of the IP header and the transmission destination port number of the UDP header of the received request message to an original address by referring to the address conversion table 131. For example, when the INVITE message shown in FIG. 19B is received from the SIP proxy server 200, the INVITE message is inversely converted to the message shown in FIG. 19C. The parts circled within ovals with dotted lines in the drawing are the converted parts, showing a case of referring to the address conversion rule shown in FIG. 15.

(2) Step S402

After the address conversion, the message is given to the group tag removing section 122.

(3) Step S403

The group tag is removed.

(4) Step S404

The group tag is given to the message destination group identifying section 150.

(5) Step S405

Thereafter, the message destination group identifying section 150 carries out the same process as the process carried out at the time of transferring the response message.

(6) Step S406-S408

After the same process as that of the response message transfer carried out, the message is transferred to the client terminal via the VPN gateway 400.

When the group tag is inserted by the second method as described above, the processes of (Process 2)-(Process 4) are carried out in the SIP proxy server 200 even though it is a request message from the outside the client group. However, the same group tag as that of the request message received by the SIP proxy server 200 is inserted into the request message that is transferred from the SIP proxy server 200. Therefore, the process of the message destination group identifying section 150 makes it possible to prevent the response message from being transferred to the client group that is different from the client group to which the client terminal as the source of the request message belongs.

For example, when the group tag is inserted into the Call-ID, the same Call-ID as that of the request message received by the SIP proxy server 200 is used for the Call-ID of the request message that is transferred from the SIP proxy server 200. Therefore, when the message destination group identifying section 150 transfers the request message to the client group S corresponding to the group tag inserted into the request message transferred from the SIP proxy server 200, it is possible to prevent the request message from being transferred to the client group that is different from the client group to which the client terminal as the source of the request message belongs.

Next, there will be described the operation of the SIP server sharing module 100 at the time of notifying presence data. Notification of presence data is carried out in the following manner. When the client terminal that issues the presence data (referred to as an issuing terminal hereinafter) notifies the presence data to the SIP proxy server 200 (although it is defined in RFC to use PUBLISH message, there are cases where the data is notified by messages different from the PUBLISH message because it is only a short time since it is regulated in RFC), the SIP proxy server 200 notifies the presence data (NOTIFY message is used) to the client terminal (referred to as a receiver terminal hereinafter) that has registered in advance a notification request for the presence data of the issuer terminal to the SIP proxy server 200 through the process of (Process 3) described above. It is necessary to prevent the presence data from being notified to the client terminals that belong to the groups other than the client group to which the issuing terminal belongs.

When the group tag is inserted by the first method, the notification request from the client terminal belonging to the group other than the client group to which the issuing terminal belongs is not registered to the SIP proxy server 200. The receiver terminal requests the notification by designating the SIP URI of the issuing terminal in the To header of the SUBSCRIBE message. However, the SIP server sharing node inserts the group tag into the SIP URI written in the To header, so that registration of the notification request from the outside the group can be prevented. For example, when the client terminal X of the group 2 requests the presence data of the client terminal A (SIP URI Use™here.com) belonging to the group 1, the SIP proxy server 200 responds that there is no such issuing terminal for the notification request from the client terminal X, because the To header of the notification request from the client terminal X is converted to UserA-group2@here.com while the SIP URI of the client terminal A is registered in the SIP server as UserA-group1@here.com.

Meanwhile, when the group tag is inserted by the second method, it is not possible to prevent the registration of the notification request that is transmitted from the client terminal outside the group, unlike the above-described case. The process of (Process 3) is carried out on the request message from the outside the group. When the group tag is inserted by the second method, the following process makes it possible to prevent the presence data from being notified to the client terminal that belongs to the group other than the client group to which the issuing terminal belongs.

Generally, the presence data from the issuing terminal is written to the body section of the PUBLISH message. The data written in the body section is written as it is in the body section of the NOTIFY message and notified to a receiver terminal. Thus, the SIP server sharing module 100 may simply insert the group tag into the body section of the PUBLISH message, and transfer the NOTIFY message to the group corresponding to the group tag inserted into the body section of the NOTIFY message. The same group tag as that inserted into the PUBLISH message is inserted to the NOTIFY message. Specifically, the group tag inserting section 121 may insert the group tag into the body section when the SIP message received from the client terminal is the PUBLISH message, and may remove the group tag inserted in the body section and notify it to the message destination group identifying section 150 when the SIP message received from the SIP proxy server 200 is the NOTIFY message.

As described above, the present invention relates to the SIP server sharing module 100 which relays the SIP messages that are transmitted and received between a plurality of client groups and the SIP proxy server that is shared by the plurality of client groups.

This SIP server sharing module includes a message source group identifying section 110, a group tag inserting section, a group tag deleting part, and a message destination group identifying part.

Regarding the client-transmitted SIP message among the SIP messages, which is transmitted to the SIP proxy server from the client terminal that belongs to the client group, the message source group identifying part identifies the client group to which the client terminal that has transmitted the client-transmitted SIP message belongs. The group tag inserting part inserts, to the client-transmitted SIP message, the group tag corresponding to the client group identified by the message-source client group identifying part. The group tag deleting part deletes the group tag contained in the server-transmitted SIP message among the SIP messages, which is transmitted from the SIP proxy server to the client terminal that belongs to the client group. The message destination group identifying part prevents the server-transmitted SIP message from being transmitted to the client terminal that belongs to the client group other than the client group corresponding to the group tag contained in the server-transmitted SIP message.

The message destination group identifying part transfers the server-transmitted SIP message to the client terminal, only when the client group corresponding to the group tag contained in the server-transmitted SIP message matches with the client group to which the actual transmission destination client terminal belongs.

When there are a plurality of virtual or physical network interfaces in the node where the SIP server sharing module is provided, the message-destination group identifying part transmits the SIP-server-transmitted message by designating different interfaces for each of the client groups that correspond to the group tags contained in the message transmitted from the SIP server.

The message destination group identifying part transmits the server-transmitted SIP messages to the transmission destination client terminal after converting the parameters contained in the IP header or the UDP header of the server-transmitted SIP messages to the parameter regions that are different for each of the client groups that correspond to the group tags contained in the SIP-server-transmitted message.

The group tag inserting part inserts the group tag corresponding to the client group identified by the message source group identifying part to one of the parameters that satisfy all of the following conditions among the parameters contained in the client-transmitted SIP message.

(1) Parameters that are not removed by transfer process carried out by the SIP proxy server that does not contain the SIP URI.

(2) (3) The same values are written for the request message and the response message that is transmitted from the SIP proxy server upon receiving the request message.

The group tag inserting part inserts the group tag corresponding to the client group identified by the message source group identifying part into the user identifier section among the SIP URI contained in the header section of the client-transmitted SIP message.

The group tag inserting part inserts the group tag also to the body section of the client-transmitted SIP message, when the client-transmitted SIP message is a message for notifying the presence data to the SIP proxy server.

When there are a plurality of client groups identified by the message source group identifying part, the group tag inserting part makes copies of the client-transmitted SIP message for the number of client groups identified by the message source group identifying part, and inserts group tags corresponding to the client groups identified by the message source group identifying part to each of the copies.

When the client-transmitted SIP message is the request message, the group tag inserting part further adds, to a Via header of the client-transmitted SIP message, the IP address of the node where the SIP server sharing module is provided and the port number the SIP server sharing module uses for waiting the SIP message. When the server-transmitted SIP message is the response message, the group tag deleting part further deletes the IP address of the node where the SIP server sharing module is provided and the port number the SIP server sharing module uses for waiting the SIP message, which are written in the Via header of the server-transmitted SIP message, while setting the IP address and the port number of the client terminal written to the Via header of the server-transmitted SIP message as the transmission destination IP address of the IP header and the transmission destination port number of the UDP header of the server-transmitted SIP message.

The SIP server sharing module of the present invention further includes an original address, an address conversion rule, and an address converting art.

The original address is the address that the terminal requests its registration to the SIP proxy server through REGISTER message.

Written in the address conversion rule is the address conversion method for mutually converting the original address and the intercept address that enables the SIP server sharing module to intercept the SIP message, when the SIP proxy server is set as the target address of the SIP message to be transmitted.

When the client-transmitted SIP message is the REGISTER message, the address converting part converts the original address contained in the Contact header of the client-transmitted SIP message into the intercept address by referring to the address conversion rule. Further, when the server-transmitted SIP message is the response message for the REGISTER message, the address converting part converts the intercept address contained in the Contac header of the server-transmitted SIP message into the original address by referring to the address conversion rule. Furthermore, when the server-transmitted SIP message is the request message, the address converting part converts the intercept address designated in the IP header and the UDP header of the server-transmitted SIP message into the original address by referring to the address conversion rule.

The address conversion method according to the present invention mutually converts the address a, which is a pair of an arbitrary IP address contained in the IP address region A of M bits and the transmission destination of either UDP or TCP, or the source part number, and the address b, which is a pair of an arbitrary IP address contained in the IP address region B of N bits and the transmission destination of either UDP or TCP, or the source port number.

When converting the address a to the address b, x bits part that satisfies X<N among the IP address of the address a is mapped to the IP address of the address b, and the (M-X) bits part as the remainder is mapped to the transmission destination of either UDP or TCP, or to the source port number of the address b. When converting the address b to the address a, the X bits part among the IP address of the address b and the (M-X) bits part among the transmission destination of either UDP or TCP, or the source port number of the address b are combined to be converted to the IP address of the address a.

As the intercept address, the address conversion rule uses the IP address region where the SIP sharing module is set as the gateway in the SIP proxy server.

As the intercept address, the address conversion rule uses the IP address region that is contained in the local backup address region.

According to the present invention, a plurality of client groups can share a SIP proxy server safely even under the environment that client terminals and the SIP proxy server exchange messages frequently. An SIP server sharing module of the present invention includes a message source group identifying section for identifying, from a client-transmitted SIP massage transmitted from a client terminal to a SIP proxy server among SIP messages, a client group to which the client terminal as a source of the client-transmitted SIP message belongs, a group tag inserting section for inserting a group tag corresponding to the client group identified by the message source group identifying section, to the client-transmitted SIP message, a group tag deleting section for deleting the group tag contained in a server-transmitted SIP message that is transmitted from the SIP proxy server to the client terminal that belongs to the client group, among the SIP messages, and a message destination group identifying section for preventing the server-transmitted SIP message from being transmitted to a client terminal that belongs to a client group other than the client group corresponding to the group tag contained in the server-transmitted SIP message. Thus, at the time of receiving the request message from the client terminal, it is possible to prevent the request message transmitted from a client terminal belonging to a specific client group from being transferred to a client terminal that belongs to a client group other than the specific terminal group, without holding data regarding from which of client terminals the request message is transmitted. Further, it is also possible to prevent the response message for the request message from being transmitted to a client terminal that belongs to a client group other than the specific client group.

Also, the present invention can deal with dynamic change of the client terminal among the client groups and dynamic forming/deletion of the client groups. Specifically, it is unnecessary to change the data on SIP URI and contact addresses registered to the SIP proxy server, even if the client terminal changes among the client groups or a client group is formed/removed. The group tag inserting section of the SIP server sharing module according to the present invention inserts the group tag corresponding to the client group into a parameter that satisfies all of the following conditions among parameters contained in the client-transmitted SIP message.

[Condition]

(1) No SIP URI contained.
(2) Not deleted through a transfer process carried out in SIP proxy server.
(3) Same values are written in a request message and a response message that is transmitted from the SIP proxy server upon receiving the request message.

Also, the present invention can prevent the presence data notified from a client terminal belonging to a specific client terminal from being notified to a client terminal that belongs to a client group other than the specific client group. The group tag inserting section of the SIP server sharing module according to the present invention inserts the group tag to a body section of a client-transmitted SIP message when the client-transmitted SIP message is a message for notifying the presence data.

Also, even when a client terminal belongs to a plurality of client groups, the present invention can prevent transfer of the request message transmitted from the client terminal and transmission of a response message for the request message to the client terminal that belongs to a client group other than the client groups to which the client terminal belongs. When there is a plurality of client groups identified by the message source group identifying section, the group tag inserting section of the SIP sharing module according to the present invention copies the client-transmitted SIP message for the number of client groups identified by the message source group identifying section, and inserts group tags corresponding to the client groups identified by the message source group identifying section to each of the copies.

Moreover, the present invention allows the SIP server sharing module to intercept the response message transmitted from the SIP proxy server even when a tunneling link is not built between the SIP proxy server and the SIP server sharing module. When the client-transmitted SIP message is a request message, the group tag inserting section of the SIP server sharing module according to the present invention further adds to a Via header of the client-transmitted SIP message, an IP address of a node in which the SIP server sharing module is provided and a port number which the SIP server sharing module uses for waiting the SIP message, and when the server-transmitted SIP message is a response message, the group tag deleting section further deletes the IP address of the node that the SIP server sharing module and the port number which the SIP server sharing module uses for waiting the SIP message written to the Via header of the server-transmitted SIP message, while setting the IP address and the port number of the client terminal written to the Via header of the server-transmitted SIP message as the transmission destination IP address of the IP header and the transmission destination port number of the UDP header of the server-transmitted SIP message.

In addition, the present invention allows the SIP server sharing module to intercept the request message transmitted from the SIP proxy server to the client terminal, even when a tunneling link is not built between the SIP proxy server and the SIP server sharing module. The SIP server sharing module of the present invention further includes an address conversion rule in which there is written an address conversion method for mutually converting original addresses that are requested to be registered to the SIP proxy server by a client terminal through a REGISTER message and an intercept address that allows the SIP server sharing module to intercept the SIP massage, when being set as the transmission destination address of the SIP message that is transmitted from the SIP proxy server; and an address converting section which converts the original address contained in a contact header of the server-transmitted SIP message to the intercept address by referring to the address conversion rule when the client-transmitted SIP message is the REGISTER message, converts the intercept address contained in the Contact header of the server-transmitted SIP message to the original message by referring to the address conversion rule when the server-transmitted SIP message is the response message for the REGISTER message, and converts the intercept address designated as the IP header message and UDP header message of the server-transmitted SIP message into the original address by referring to the address conversion rule when the server-transmitted SIP message is the request message.

Furthermore, the present invention can carry out inverse conversion of the intercept address contained in the SIP message transmitted from the SIP proxy server into a unique original address, even when the IP address region secured as the intercept address is narrower than the IP address region that can be taken for the original address. In the address conversion rule of the SIP server sharing module according to the present invention, there is written the address conversion method for mutually converting an address a that is a pair of an arbitrary IP address and the transmission destination of UDP or TCP or source port number contained in the IP address regions A of M bits and an address b that is a pair of an arbitrary IP address and the transmission destination of UDP or TCP, or source port number contained in the IP address regions B of N bits. The address conversion method maps X bits (X<N) part of the IP address of the address a to the IP address of the address b, and maps the (M-X) bits part as the remainder to the transmission destination of the UDP or TCP, or the source port number of the address b for converting the address a to the address b. For converting the address b to the address a, the address conversion method converts a combination of the X bits part of the IP address of the address b and (M-X) bits part of the transmission destination of the UDP or TCP, or the source port number of the address b to the IP address of the address a.

What is claimed is:

1. An SIP (Session Initiation Protocol) server sharing module which relays SIP messages which are transmitted and received between a plurality of client groups and a SIP proxy server shared by said plurality of client groups, comprising;
a message source group identifying section configured to identify a specific client group to which a specific client terminal belongs which transmits a client transmission SIP message, from said client transmission SIP message which is transmitted to said SIP proxy server from each of client terminals belonging to said plurality of client groups;
a group tag insetting section configured to insert a group tag corresponding to said specific client group identified by said message source group identifying section in said client transmission SIP message;
a group tag removing section configured to remove a group tag contained in a server transmission SIP message transmitted to a destination client terminal, which belongs to said specific client group, from said SIP proxy server; and
a message destination group identifying section configured to prevent said server transmission SIP message from being transmitted to a client terminal which belongs to a client group different from said specific client group corresponding to said group tag contained in said server transmission SIP message.

2. The SIP server sharing module according to claim 1, wherein said message destination group identifying section transfers said server transmission SIP message to said destination client terminal, when said specific client group corresponding to said group tag contained in said server transmission SIP message and a client group to which said destination client terminal of said server transmission SIP message belongs are coincident with each other.

3. The SIP server sharing module according to claim 1, wherein when a plurality of virtual or physical network interfaces exists in a node where said SIP server sharing module is provided, said message destination group identifying section specifies a network interface different for every client group corresponding to said group tag contained in said server transmission SIP message and transmits said server transmission SIP message.

4. The SIP server sharing module according to claim 1, wherein said message destination group identifying section converts a parameter contained in an IP header or UDP header of said server transmission SIP message into a parameter area different for every client group corresponding to said group tag contained in said server transmission SIP message, and then transmits said server transmission SIP message to said destination client terminal.

5. The SIP server sharing module according to claim 1, wherein said group tag insetting section inserts said group tag corresponding to said specific client group identified by said message source group identifying section, into either of parameters, that meet a condition that the parameters does not contain URI to be registered on said SIP proxy server, the parameters is not erased through the transfer process by said SIP proxy server, and a same value is written in a request message and a response message transmitted from said SIP proxy server in response to reception of the request message, among parameters contained in said client transmission SIP messages.

6. The SIP server sharing module according to claim 1, wherein said group tag insetting section inserts said group tag corresponding to said specific client group identified by said message source group identifying section into a portion of a user identifier of URI contained in a header section of aid client transmission SIP message.

7. The SIP server sharing module according to claim 1, wherein said group tag insetting section further inserts said group tag in a body section of said client transmission SIP message, when said client transmission SIP message is a message to notify presence data to said SIP proxy server.

8. The SIP server sharing module according to claim 1, wherein when said message source group identifying section identifies said plurality of client groups, said group tag insetting section produces copies of said client transmission SIP message for said plurality of client groups identified by said message source group identifying section, and inserts said group tag corresponding to each of said plurality of client groups identified by said message source group identifying section into corresponding one of said copies.

9. The SIP server sharing module according to claim 1, wherein said group tag insetting section additionally writes an IP address of a node in which said SIP server sharing module is arranged and a port number used for waiting for said SIP message into a Via header of said client transmission SIP message, when said client transmission SIP message is a request message, and
when said server transmission SIP message is a response message to said request message, said group tag removing section removes the IP address and the port number used from the Via header of said client transmission SIP message, and sets an IP address and a port number of a client terminal written in the Via header of said server transmission SIP message to a destination IP address of a IP header and a destination port number of the UDP header of the IP header of said server transmission SIP message.

10. The SIP server sharing module according to claim 1, further comprising:
address conversion rule; and
an address converting section,
wherein in said address conversion rule, is described an address conversion method of mutually converting an original address as an address which said client terminal requests to register on said SIP proxy server by use of a REGISTER message, and an interception address as an address to intercept said SIP message when being set in a destination address of the SIP message transmitted by said SIP proxy server, and
said address converting section converts an original address contained in a Contact header of said client transmission SIP message into the interception address by referring to said address conversion rule, when said client transmission SIP message is a REGISTER message, converts the interception address contained in the Contact header of said server transmission SIP message into the original address by referring to said address conversion rule, when said server transmission SIP message is the response message to the REGISTER message, and converts an interception address specified by an IP header and a UDP header of said server transmission SIP message into the original address by referring to said address conversion rule, when said server transmission SIP message is the request message.

11. The SIP server sharing module according to claim 10, wherein said address conversion method is a conversion method of mutually converting an address a which is an optional IP address contained in an IP address area A having a width of M bits, which is a destination of UDP or TCP, or which constitutes a pair with a source port number, and an address b which is an optional IP address contained in an IP address area B having a width of N bits, which is a destination of UDSP or TCP or which constitutes a pair with a source port number,
in said address conversion method, an X-bit portion meeting X<N in the IP address of said address a is mapped to the IP address of said address b, and a remaining (M-X)-bit portion is mapped to the destination of UDP or TCP or the source port number of said address b, in case of conversion of said address a into said address b, and
a combination of an X-bit portion of the IP address of said address b, and an (M-X)-bit portion of the destination of UDP or TCP or the source port number of said address b is mapped to the IP address of said address a, in case of conversion of said address b into said address a.

12. The SIP server sharing module according to claim 10, wherein said address conversion rule uses the IP address area when said SIP server sharing module is set as a gateway in said SIP proxy server as an interception address.

13. The SIP server sharing module according to claim 10, wherein said address conversion rule uses an IP address area contained in a local loop back address area as an interception address.

14. An address conversion method for mutually converting an address a which is an optional IP address contained in an IP address area A with a width of M bits, is a destination of UDP or TCP, or constitutes a pair with a source port number, and an address b which is an optional IP address contained in an IP address area B with a width of N bits, is a destination of UDP or TCP, or constitutes a pair with a source port number, comprising;
(A) mapping an X-bit portion meeting X<N of the IP address of said address a to the IP address of said address b in case to convert said address a into said address b;
(B) mapping a remaining (M-X)-bit portion of the IP address of said address a to the destination of UDP or TCP of said address b, or said source port number; and
(C) mapping a combination of an X-bit portion of the IP address of said address b and an (M-X)-bit portion of the destination of UDP or TCP of said address b or the source port number into the IP address of said address a in case of conversion of said address b into said address a.

15. A method of relaying a SIP message, comprising:
(a) when a message is received, determining whether the message is transmitted from a client terminal or a SIP proxy server;
(b) determining whether or not address conversion is necessary when the received message is from said client terminal;
(c) transferring the received message to said SIP proxy server without any process when the address conversion is not necessary;
(d) determining whether or not the received message is a REGISTER message, when the address conversion is necessary;
(e) carrying out a forward conversion an original address as an IP address or a port number contained in a Contact header of a header section, when the received message is the REGISTER message; and
(f) transmitting the REGISTER message to said SIP proxy server after the forward conversion.

16. The method according to claim 15, further comprising:
(g) determining whether or not the address conversion is necessary, when the received message is a SIP message from said SIP proxy server;
(h) removing a group tag contained in said SIP message when the address conversion is unnecessary;
(i) determining whether or not said SIP message is a request message, when the address conversion is necessary;
(j) carrying out an inverse conversion of a destination address or a destination port number of an IP header of said SIP message from an intercept address to said original address such that said SIP message is transferred to said client terminal, when said SIP message is a request message; and
(k) removing a group tag contained in said SIP message after the inverse conversion.

17. The method according to claim 16, further comprising:
(1) determining whether said SIP message is a response message to the REGISTER message, when said SIP message is said response message;
(m) carrying out inverse conversion of an IP address contained in the Contact header or the interception address as a port number into said original address, when said SIP message is said response message to the REGISTER message; and
(n) removing a group tag contained in said SIP message after the inverse conversion.

18. A computer-readable software product for realizing a method of relaying a SIP message, wherein said method comprises:
(a) when a message is received, determining whether the message is transmitted from a client terminal or a SIP proxy server;
(b) determining whether or not address conversion is necessary when the received message is from said client terminal;
(c) transferring the received message to said SIP proxy server without any process when the address conversion is not necessary;
(d) determining whether or not the received message is a REGISTER message, when the address conversion is necessary;
(e) carrying out a forward conversion an original address as an IP address or a port number contained in a Contact header of a header section, when the received message is the REGISTER message; and
(f) transmitting the REGISTER message to said SIP proxy server after the forward conversion.

19. The computer-readable software product according to claim 18, wherein said method further comprises:
(g) determining whether or not the address conversion is necessary, when the received message is a SIP message from said SIP proxy server;
(h) removing a group tag contained in said SIP message when the address conversion is unnecessary;
(i) determining whether or not said SIP message is a request message, when the address conversion is necessary;
(j) carrying out an inverse conversion of a destination address or a destination port number of an IP header of said SIP message from an intercept address to said original address such that said SIP message is transferred to said client terminal, when said SIP message is a request message; and
(k) removing a group tag contained in said SIP message after the inverse conversion.

20. The computer-readable software product according to claim 18, wherein said method further comprises:
(1) determining whether said SIP message is a response message to the REGISTER message, when said SIP message is said response message;
(m) carrying out inverse conversion of an IP address contained in the Contact header or the interception address as a port number into said original address, when said SIP message is said response message to the REGISTER message; and
(n) removing a group tag contained in said SIP message after the inverse conversion.
